(19) United States
(12) Patent Application Publication
(10) Pub. No.: US 2016/0047758 A1
(43) Pub. Date: Feb. 18, 2016

(54) NOVEL MATERIALS USEFUL FOR RADIOGRAPHIC IMAGING OF CONSTRUCTION MATERIALS AND METHODS USING SAME

(71) Applicant: LEHIGH UNIVERSITY, Bethlehem, PA (US)

(72) Inventors: STEPHEN PESSIKI, NAZARETH, PA (US); WESLEY J. KELLER, PHILADELPHIA, PA (US)

(21) Appl. No.: 14/829,433

(22) Filed: Aug. 18, 2015

Related U.S. Application Data
(60) Provisional application No. 62/038,620, filed on Aug. 18, 2014.

(51) Int. Cl. G01N 23/04; G01N 23/087

(52) U.S. Cl. CPC G01N 23/04; G01N 23/087

(57) ABSTRACT

The invention includes compositions that are useful for improving contrast in radiographic images. In certain embodiments, the compositions of the invention may be used in cementitious materials, thus allowing the analysis of grouts located around tendons and tendon anchorage regions around steel post-tensioning strands. The invention further includes methods of performing radiographic inspection using the compositions of the invention.

### CROSS-REFERENCE TO RELATED APPLICATIONS

The present application claims priority under 35 U.S.C. §119(e) to U.S. Provisional Patent Application No. 62/038,620, filed Aug. 18, 2014, which is incorporated herein by reference in its entirety.

### STATEMENT REGARDING FEDERALLY SPONSORED RESEARCH OR DEVELOPMENT

This invention was made with government support under grant number DTFH61-11-H-00027 awarded by the Federal Highway Administration (FHWA/Department of Transportation). The government has certain rights in the invention.

### BACKGROUND

Radiography has found widespread use as a nondestructive method for subsurface visualization and flaw detection. The test procedure utilizes the electromagnetic waves emitted from a radiation source (either an X-ray generator or a radioisotope gamma-ray source) to penetrate the test object, exposing a photostimulable detector on the opposing surface. Since the atomic structure of the surveyed material influences photon attenuation and scattering phenomena, spatial variation in material composition leads to spatial variation in radiation intensity reaching the detector. In modern digital radiographic testing, these detector readings are digitized and converted to pixel intensity values, through which spatial variations can be visualized on a computer monitor as color contrast.

The ability of radiographic imaging to accommodate complex geometries and heterogeneous/composite materials makes it an effective and versatile method for structural assessment. Advancements in radiographic imaging equipment, such as the development of portable MeV X-ray generators (which offer superior penetrating power, reduced exposure times, and improved worksite safety compared to gamma-ray producing isotope sources) have made radiography a more viable method for field evaluation of concrete infrastructure.

One field application that has received considerable attention in recent years is the detection of grout void(s) in the tendons and tendon anchorage regions of post-tensioned concrete bridges. In order to protect the steel post-tensioning strands from exposure to chlorides and other degrading agents over the service life of the bridge, a cementitious grout is pumped into the tendon ducts and anchorage hardware to encase the strands. Research and experience, however, have shown that incomplete grouting of post-tensioning systems is a frequent occurrence during bridge construction, and that the absence of protective grout encasement for the steel strands can lead to early age corrosion.

One of the major obstacles to the use of radiographic inspection for grout void detection in post-tensioned concrete construction is that X-ray attenuation in cementitious grout is similar to the attenuation in the surrounding concrete, considering typical energy levels used for field inspection of concrete structures. As a result, grout void detection is strongly influenced by the volumetric fraction of the void in relation to the thickness of the structure, where small voids in a thick concrete section are difficult to detect. The magnetic flux leakage (MFL) method for inspecting external tendons does not address embedded tendons or tendon anchorage regions where limited access prohibits MFL testing.

There is a need in the art for novel compositions and methods that allow for the radiographic inspection of materials such as tendons and tendon anchorage regions around steel post-tensioning strands. In certain aspects, such compositions and methods should allow for detection of grout voids, which may be associated with early strand corrosion. Early detection of grout voids allows for proper structural repairs, avoiding structural failure. The present invention meets this need.

### BRIEF SUMMARY

The invention provides a composition comprising a construction material and at least one photon attenuation inclusion (PAI) particle. The invention further provides a method of performing radiographic inspection of a composition, wherein the composition is in contact with a physical structure. The invention further provides a method of applying a composition to a physical structure, the method comprising contacting the composition with the physical structure. The invention further provides a kit comprising at least one photon attenuation inclusion (PAI) particle, an applicator and instructional material, wherein the instructional material recites the preparation of a composition comprising a construction material and the at least one PAI particle.

In certain embodiments, the composition comprises a construction material and at least one photon attenuation inclusion (PAI) particle. In other embodiments, the composition consists essentially of the construction material and the at least one PAI particle. In yet other embodiments, for at least one X-ray radiation level the radiation attenuation coefficient of the composition is at least 5% higher than the radiation attenuation coefficient of the composition in the absence of the at least one PAI particle. In yet other embodiments, the radiation attenuation coefficient of the composition is at least 50% higher than the radiation attenuation coefficient of the composition in the absence of the at least one PAI particle. In yet other embodiments, the % PAI volume fraction in the composition ranges from about 1% to about 75%. In yet other embodiments, the % PAI volume fraction in the composition ranges from about 5% to about 20%. In yet other embodiments, the % PAI volume fraction in the composition ranges from about 5% to about 10%.

In certain embodiments, the PAI is at least one selected from the group consisting of a lead source, iron, carbon/stainless steel, and a barium source. In other embodiments, the lead source is at least one selected from the group consisting of elemental lead. a lead oxide, a lead hydroxide, and a lead salt. In yet other embodiments, the barium source is at least one selected from the group consisting of a barium salt, a barium hydroxide, and a barium oxide. In yet other embodiments, the barium salt is at least one selected from the group consisting of barium sulfate and barium carbonate.

In certain embodiments, the construction material comprises at least one selected from the group consisting of concrete, clay, grout, sand, aggregate, masonry and steel-concrete. In other embodiments, the construction material comprises cement. In yet other embodiments, the construction material comprises cementitious grout. In yet other embodiments, the PAI is in at least one form selected from the group consisting of powder, fiber, sphere, pellet, slurry and liquid.

In certain embodiments, the at least one X-ray radiation level ranges from about 1 keV to about 10 MeV. In other embodiments, the at least one X-ray radiation ranges from about 10 keV to about 500 keV. In yet other embodiments, the PAI has a pair production threshold energy, and wherein the at least one X-ray radiation level is about equal to or lower than the PAI's pair production threshold energy.

In certain embodiments, the physical structure comprises at least one selected from the group consisting of tendons and/or tendon anchorage regions around steel post-tensioning strands, grouted masonry construction, steel-concrete composite construction, and other forms of concrete construction.

In certain embodiments, the method comprises the steps of exposing at least one point of the composition to X-ray radiation of a first energy level and measuring radiation that emerges from the composition, thereby obtaining a first radiographic image of the composition.

In certain embodiments, the method further comprises exposing at least one point of the physical structure in the absence of the composition to X-ray radiation of a given energy level and measuring radiation that emerges from the physical structure in the absence of the composition, thereby obtaining a radiographic image of the physical structure in the absence of the composition.

In certain embodiments, the method further comprises comparing the radiographic image of the composition and the radiographic image of the physical structure in the absence of the composition, thereby obtaining a radiographic image of the composition with improved contrast-to-noise ratio.

In certain embodiments, analysis of the radiographic image of the compositions allows for detection of at least one selected from the group consisting of a void, multiple voids, fracture and crack.

In certain embodiments, the method further comprises exposing at least one point of the composition to X-ray radiation of a second energy level and measuring radiation that emerges from the composition, thus obtaining a second radiographic image of the composition, wherein the first energy is distinct from the second energy.

In certain embodiments, the method further comprises applying a first scale factor to the first radiographic image to generate a first scaled image, applying a second scale factor to the second radiographic image to generate a second scaled image, and combining the first and second scaled images to generate an enhanced radiographic image, wherein the first and second scale factor are selected such that the image of the physical structure is substantially suppressed in the enhanced radiographic image.

In certain embodiments, the first and second energies are independently in the range of about 1 MeV to about 10 MeV.

In certain embodiments, the composition is fluid when contacted with the physical structure and becomes rigid after a curing time. In other embodiments, the method further comprises performing radiographic inspection of the composition when the composition is in contact with the physical structure, at a time point that is shorter than the composition's curing time. In yet other embodiments, the method further comprises performing radiographic inspection of the composition when the composition is in contact with the physical structure, at a time point that is equal to or longer than the composition's curing time.

### BRIEF DESCRIPTION OF THE FIGURES

For the purpose of illustrating the invention, there are depicted in the drawings certain embodiments in accordance with the present invention. However, the invention is not limited to the precise arrangements and instrumentalities of the embodiments depicted in the drawings.

FIG. 1 is a non-limiting illustration of attenuation coefficients for various materials.

FIGS. 2A-2C comprise non-limiting aspects of experimental radiographic imaging. FIG. 2A is an exemplary scheme illustrating a shielding block assembly geometry. FIG. 2B is an exemplary illustration of a shielding block assembly shown without the removable wall panel or test specimen. FIG. 2C is an exemplary illustration of a final test configuration.

FIG. 3 illustrates exemplary optical density measurements for shielded and unshielded 15 cm diameter×30 cm thick Portland cement concrete specimens (350 keV-12.85 mA-Agfa D4 film).

FIG. 4 illustrates exemplary optical density measurements for 30 cm thick grout specimens with and without PAI (350 keV-12.85 mA-480 s-Agfa D4 film).

FIG. 5 illustrates exemplary components of the CIVA RT virtual radiography model.

FIG. 6 illustrates an exemplary CIVA RT virtual radiography algorithm.

FIG. 7 illustrates an exemplary 350 keV X-ray emission spectrum.

FIG. 8A illustrates an exemplary comparison of optical density measurements for experimental and virtual radiographs of conventional and PAI grout specimens. FIG. 8B illustrates elemental composition of grout and PAI materials based on X-ray diffraction analysis (*=representative composition).

FIG. 9 illustrates an exemplary CIVA RT grout void detection simulation.

FIG. 10 illustrates exemplary attenuation coefficients for PC Concrete and 30% BaCO₃ (2-6 MeV).

FIG. 11 illustrates an exemplary CIVA RT dual energy radiography material discrimination simulation.

FIG. 12 illustrates an exemplary radiographic testing, with defects illustrated.

FIG. 13 illustrates an exemplary rendering of a 15 cm diameter×25 cm DCM cylinder: (a) hydrated cement mortar (isometric view), (b) discrete coarse aggregate population (isometric view), (c) discrete coarse aggregate population (top view).

FIG. 14 illustrates exemplary CIVA RT concrete cylinder radiographic inspection models (DCM specimens shown): (a) 15 cm diameter×5 cm, (b) 15 cm diameter×10 cm, and (c) 15 cm diameter×25 cm.

FIG. 15 illustrates exemplary CIVA RT virtual radiographs for the concrete cylinder study: (a) 15 cm diameter×5 cm DCM; (b) 15 cm diameter×10 cm DCM; (c) 15 cm diameter×25 cm DCM.

FIG. 16 illustrates Experimental radiographs of PC concrete cylinder specimens: (a) 15 cm diameter×5 cm (250 keV/15 mA/30 s); (b) 15 cm diameter×10 cm (300 keV/15 mA/45 s). Detector: 50 μm resolution imaging plate, 115 cm offset.

FIG. 17 illustrates exemplary ROI pixel intensity distribution for the DCM and HCM cylinder specimens.

FIG. 18 illustrates an exemplary concrete mix used in a non-limiting model validation study.

FIG. 19 illustrates exemplary results for experimental images relating to the model validation studies.

FIGS. 20A-20C illustrate optical density results obtained for 20 cm thick specimens (FIG. 20A), 30 cm thick specimens (FIG. 20B) and 30 cm thick specimens, taking into account the air gap between specimen and shielding assembly (FIG. 20C).

FIG. 21 illustrates an exemplary CIVA RT study for radiographic inspection of post-tensioning anchorage regions: (a) rending of anchorage hardware and steel strands, (b) rending of CIVA RT model, and (c) virtual radiograph displaying the notched region.

FIG. 22 is a non-limiting illustration of attenuation coefficients for various materials.

FIG. 23 is a set of exemplary graphs illustrating the comparison of pixel intensity in the grouted and voided/water-filled duct regions.

FIG. 24 is an exemplary illustration of PAI seeding for combined radiographic testing-digital volume correlation analysis: (a)-(b) simulated radiographic test shots, (c) representative virtual radiograph displaying individual PAI locations. PAI positional and dimensional data in the projected radiographic images facilitates 3D reconstructions of the PAI population for digital volume correlation.

FIG. 25 illustrates an exemplary virtual radiographic inspection of ungrouted tendon regions. Optimal emission energy for grout void detection in this specimen was between 350 keV and 6 MeV.

FIG. 26 illustrates an exemplary inspection of anchorage regions. Simulations considered only direct (uncollided flux) radiation (Beer-Lambert law).

### DETAILED DESCRIPTION OF THE INVENTION

The present invention provides novel compositions and methods that allow for the radiographic inspection of materials, which may in certain embodiments be composite materials, such as tendons and tendon anchorage regions around steel post-tensioning strands. In certain embodiments, the compositions and methods in accordance with the present invention allow for detection of grout void(s) (including honeycomb voids), cracks and/or fractures around tendons and tendon anchorages used in post-tensioned concrete bridges.

As demonstrated herein, the compositions and methods in accordance with the present invention allow for the improvement of radiographic visualization of embedded cementitious materials. Further, the compositions and methods in accordance with the present invention allow for grout void(s) detection in post-tensioned concrete construction.

The studies described herein relate in part to the discovery of cementitious materials comprising photon attenuating inclusion (PAI) particles. In certain embodiments, PAIS are defined as high atomic number (high Z) materials, which possess advantageous radiation attenuation properties, that are embedded within the parent material for the purpose of altering its radiation attenuation characteristics. In one aspect, PAIS can be used to tune radiation attenuation in the component materials of a composite structure (with regard to both material attenuation characteristics and the radiation emission spectrum) in order to improve contrast in radiographic images. One skilled in the art will contemplate that certain descriptions and experiments provided herein are directed toward a specific practical application, which relates to grout void(s) detection in post-tensioned concrete construction, but the teachings of the present invention can be readily adapted to a broader range of applications in order to enhance radiographic imaging of composite structures. Additional examples of applications of the technology include grouted masonry construction, steel-concrete composite construction, and other forms of concrete construction.

As demonstrated herein, radiographic imaging of conventional and PAI cementitious grouts was performed. The results were used to evaluate candidate PAI materials and concentrations that may augment radiation attenuation of the parent material, and to validate material models for virtual radiography simulations. The use of PAIS for enhancing grout void detection in the tendons of post-tensioned concrete structures was evaluated for a range of X-ray emission spectra. Further, the application of PAIS to dual energy radiography material discrimination studies was investigated.

### Definitions

As used herein, each of the following terms has the meaning associated with it in this section.

As used herein, unless defined otherwise, all technical and scientific terms generally have the same meaning as commonly understood by one of ordinary skill in the art to which this invention belongs. Generally, the nomenclature used herein and the laboratory procedures in surface chemistry are those well-known and commonly employed in the art.

As used herein, the articles “a” and “an” refer to one or to more than one (i.e. to at least one) of the grammatical object of the article. By way of example, “an element” means one element or more than one element.

As used herein, the term “about” will be understood by persons of ordinary skill in the art and will vary to some extent on the context in which it is used. As used herein, “about” when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

As used herein, the term “DCM” refers to discrete coarse aggregate concrete model.

As used herein, the term “HCM” refers to a homogenized concrete model (HCM).

As used herein, the term “PAI” refers to a photon attenuating inclusion material, which may be provided as particles, in a non-limiting example. In certain embodiments, the PAI comprises a high atomic number (high Z) material, such as but not limited to barium and/or lead and/or any other appropriate heavy metal.

As used herein, the term “instructional material” includes a publication, a recording, a diagram, or any other medium of expression that may be used to communicate the usefulness of the compositions, devices and/or methods of the present invention. In certain embodiments, the instructional material may be part of a kit useful for generating compositions of the present invention. The instructional material of the kit may, for example, be affixed to a container that contains compositions and/or devices of the present invention or be shipped together with a container that contains compositions and/or devices of the present invention. Alternatively, the instructional material may be shipped separately from the container with the intention that the recipient uses the instructional material and compositions, methods and/or devices cooperatively. For example, the instructional material is for use of a kit; or instructions for use of the compositions, methods and/or devices of the present invention.

As used herein, the term “μm” is the abbreviation for “micron” or “micrometer”, and it is understood that 1 μm=0.001 mm=10⁻⁶ m=1 millionth of a meter.

As used herein, the term “nm” is the abbreviation for “nanometer” and it is understood that 1 nm=1 nanometer=10⁻⁹ m=1 billionth of a meter.

As used herein, the term “physical structure” refers to any structure with which the compositions of the invention may be contacted.

Throughout this disclosure, various aspects of the present invention may be presented in a range format. It should be understood that the description in range format is merely for convenience and brevity and should not be construed as an inflexible limitation on the scope of the present invention. Accordingly, the description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6, and so on, as well as individual numbers within that range, for example, 1, 2, 2.7, 3, 4, 5, 5.3, and 6. This applies regardless of the breadth of the range.

### Compositions

The invention provides compositions, which are exemplified in a non-limiting manner herein. The invention should not be construed to be limited to the description herein, and contemplates any combination(s) of the embodiments recited herein.

In one aspect, the invention provides a composition comprising a material and photon attenuation inclusion (PAI) particles, wherein for at least one X-ray radiation level the radiation attenuation coefficient of the composition is at least 5% higher than the radiation attenuation coefficient of the composition in the absence of the PAI particles.

In certain embodiments, the material is a composite. In other embodiments, the material is a construction material. In yet other embodiments, the composition consists essentially of the material and the PAI particles.

In certain embodiments, for at least one X-ray radiation level the radiation attenuation coefficient of the composition is at least 5% higher, 10% higher, 15% higher, 20% higher, 25% higher, 30% higher, 35% higher, 40% higher, 45% higher, 50% higher, 55% higher, 60% higher, 65% higher, 70% higher, 75% higher, 80% higher, 85% higher, 90% higher, 95% higher, 100% higher, 110% higher, 120% higher, 130% higher, 140% higher, 150% higher, 175% higher, 200% higher, 225% higher, 250% higher, 275% higher, 300% higher, 350% higher, 400% higher, 450% higher, 500% higher, 550% higher, 600% higher, 650% higher, 700% higher, 750% higher, 800% higher, 850% higher, 900% higher, 950% higher, 1000% higher or higher than 1000% than the radiation attenuation coefficient of the composition in the absence of the PAI particles.

In certain embodiments, the % PAI volume fraction in the composition ranges from about 1% to about 75%. In other embodiments, the % PAI volume fraction in the composition ranges from about 1% to about 75%, from about 1% to about 70%, from about 1% to about 65%, from about 1% to about 60%, from about 1% to about 55%, from about 1% to about 50%, from about 1% to about 45%, from about 1% to about 40%, from about 1% to about 35%, from about 1% to about 30%, from about 1% to about 25%, from about 1% to about 20%, or from about 1% to about 15%. In yet other embodiments, the % PAI volume fraction in the composition ranges from about 5% to about 75%, from about 5% to about 70%, from about 5% to about 65%, from about 5% to about 60%, from about 5% to about 55%, from about 5% to about 50%, from about 5% to about 45%, from about 5% to about 40%, from about 5% to about 35%, from about 5% to about 30%, from about 5% to about 25%, from about 5% to about 20%, or from about 5% to about 15%. In yet other embodiments, the % PAI volume fraction in the composition ranges from about 10% to about 75%, from about 10% to about 70%, from about 10% to about 65%, from about 10% to about 60%, from about 10% to about 55%, from about 10% to about 50%, from about 10% to about 45%, from about 10% to about 40%, from about 10% to about 35%, from about 10% to about 30%, from about 10% to about 25%, from about 10% to about 20%, or from about 10% to about 15%. In yet other embodiments, the % PAI volume fraction in the composition ranges from about 20% to about 75%, from about 20% to about 70%, from about 20% to about 65%, from about 20% to about 60%, from about 20% to about 55%, from about 20% to about 50%, from about 20% to about 45%, from about 20% to about 40%, from about 20% to about 35%, from about 20% to about 30%, or from about 20% to about 25%. In yet other embodiments, the % PAI volume fraction in the composition ranges from about 5% to about 20%. In yet other embodiments, the % PAI volume fraction in the composition ranges from about 5% to about 10%. In yet other embodiments, the PAI particle is in at least one form selected from the group consisting of powder, fiber, sphere, pellet, slurry and solution (liquid form).

In certain embodiments, the PAI is at least one selected from the group consisting of a lead source, iron, carbon/stainless steel, and a barium source. In other embodiments, the lead source is at least one selected from the group consisting of elemental lead, a lead oxide, a lead hydroxide, and a lead salt, such as lead phosphate and/or lead sulfate and/or lead carbonate. In yet other embodiments, the barium source is a barium oxide, a barium hydroxide, and a barium salt. In yet other embodiments, the barium salt is at least one selected from the group consisting of barium sulfate and/or barium phosphate and/or barium carbonate.

In certain embodiments, the material comprises at least one selected from the group consisting of concrete, clay, grout, sand, aggregate, masonry and steel-concrete. In other embodiments, the material comprises cementitious grout.

In certain embodiments, the at least one X-ray radiation level ranges from about 1 keV to about 10 MeV, from about 1 keV to about 9 MeV, from about 1 keV to about 8 MeV, from about 1 keV to about 7 MeV, from about 1 keV to about 6 MeV, or from about 1 keV to about 5 MeV. In other embodiments, the at least one X-ray radiation level ranges from about 2 keV to about 10 MeV, from about 2 keV to about 9 MeV, from about 2 keV to about 8 MeV, from about 2 keV to about 7 MeV, from about 2 keV to about 6 MeV, or from about 2 keV to about 5 MeV. In other embodiments, the at least one X-ray radiation ranges from about 10 keV to about 500 keV, about 10 keV to about 400 keV, about 10 keV to about 300 keV, about 10 keV to about 200 keV, about 10 keV to about 100 keV, about 20 keV to about 500 keV, about 30 keV to about 500 keV, about 40 keV to about 500 keV, about 50 keV to about 500 keV, about 60 keV to about 500 keV, about 70 keV to about 500 keV, about 80 keV to about 500 keV, about 90 keV to about 500 keV, or about 100 keV to about 500 keV. In yet other embodiments, the PAI has a pair production threshold energy, and wherein the at least one X-ray radiation level is about equal to or lower than the PAI's pair production threshold energy.

### Methods

The invention provides methods of performing radiographic inspection of a composition, which are exemplified in a non-limiting manner herein. In certain embodiments, the composition is in contact with a structure. The invention should not be construed to be limited to the description herein, and contemplates any combination(s) of the embodiments recited herein.

In certain embodiments, the method comprises exposing at least one point of the composition of the invention to X-ray radiation of a first energy level, and measuring radiation that emerges from the composition, thereby obtaining a first radiographic image of the composition. In other embodiments, for the first X-ray radiation energy level the radiation attenuation coefficient of the composition is at least 5% higher than the radiation attenuation coefficient of the composition in the absence of the PAI particles.

In certain embodiments, the composition comprises cement. In other embodiments, the composition comprises cementitious grout. In yet other embodiments, the physical structure comprises tendons and/or tendon anchorage regions around steel post-tensioning strands, masonry construction, steel-concrete composite construction, and other forms of concrete construction.

In certain embodiments, the method further comprises exposing at least one point of the physical structure in the absence of the composition to X-ray radiation of a given energy level and measuring radiation that emerges from the physical structure in the absence of the composition, thereby obtaining a radiographic image of the physical structure in the absence of the composition.

In certain embodiments, the method further comprises comparing the radiographic image of the composition and the radiographic image of the physical structure in the absence of the composition, thereby obtaining a radiographic image of the composition with improved contrast-to-noise ratio.

In certain embodiments, analysis of the radiographic image of the compositions allows for detection of at least one selected from the group consisting of a void, multiple voids (such as honeycomb voids), fracture, and crack.

In certain embodiments, the method further comprises exposing at least one point of the composition to X-ray radiation of a second energy level and measuring radiation that emerges from the composition, thus obtaining a second radiographic image of the composition, wherein the first energy is distinct from the second energy, wherein for the second X-ray radiation energy level the radiation attenuation coefficient of the composition is at least 5% higher than the radiation attenuation coefficient of the composition in the absence of the PAI particles.

In certain embodiments, the method further comprises applying a first scale factor to the first radiographic image to generate a first scaled image, applying a second scale factor to the second radiographic image to generate a second scaled image, and combining the first and second scaled images to generate an enhanced radiographic image, wherein the first and second scale factor are selected such that the image of the physical structure is substantially suppressed in the enhanced radiographic image.

In certain embodiments, the first and second energies are independently in the range of about 1 keV to about 10 MeV, from about 1 keV to about 9 MeV, from about 1 keV to about 8 MeV, from about 1 keV to about 7 MeV, from about 1 keV to about 6 MeV, or from about 1 keV to about 5 MeV. In other embodiments, the at least one X-ray radiation level ranges from about 2 keV to about 10 MeV, from about 2 keV to about 9 MeV, from about 2 keV to about 8 MeV, from about 2 keV to about 7 MeV, from about 2 keV to about 6 MeV, or from about 2 keV to about 5 MeV.

The invention further provides methods of applying a composition of the invention to a physical structure, which are exemplified in a non-limiting manner herein. The invention should not be construed to be limited to the description herein, and contemplates any combination(s) of the embodiments recited herein.

In certain embodiments, the method comprises contacting the composition with the physical structure, wherein the composition comprises a material, which in certain embodiments is a composite material, and at least one photon attenuation inclusion (PAI) particle, wherein for at least one X-ray radiation level the radiation attenuation coefficient of the composition is at least 5% higher than the radiation attenuation coefficient of the composition in the absence of the at least one PAI particle. In other embodiments, the composition is fluid when contacted with the physical structure and becomes rigid after a curing time. In yet other embodiments, the method further comprises performing radiographic inspection of the composition when the composition is in contact with the physical structure, at a time point that is shorter than the composition's curing time. In yet other embodiments, the method further comprises performing radiographic inspection of the composition when the composition is in contact with the physical structure, at a time point that is equal to or longer than the composition's curing time.

Every formulation or combination of components described or exemplified can be used to practice the invention, unless otherwise stated. Specific names of compounds are intended to be exemplary, as it is known that one of ordinary skill in the art can name the same compounds differently. When a compound is described herein such that a particular isomer or variant of the compound is not specified, for example, in a formula or in a chemical name, that description is intended to include each isomer and/or variant of the compound described individual or in any combination. Although the description herein contains many embodiments, these should not be construed as limiting the scope of the present invention but as merely providing illustrations of some of the presently preferred embodiments of the present invention.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application. In general, the terms and phrases used herein have their art-recognized meaning, which can be found by reference to standard texts, journal references and contexts known to those skilled in the art. Any preceding definitions are provided to clarify their specific use in the context of the present invention.

The following examples further illustrate aspects of the present invention. However, they are in no way a limitation of the teachings or disclosure of the present invention as set forth herein.

### EXAMPLES

The invention is now described with reference to the following Examples. These Examples are provided for the purpose of illustration only, and the invention is not limited to these Examples, but rather encompasses all variations that are evident as a result of the teachings provided herein.

### Example 1

### Radiographic Imaging of Conventional and PAI Grout Specimens

1.1. Grout Specimens and Material Characterization

In order to generate experimental data for evaluating candidate PAI materials and concentrations, and to provide benchmark data for the validation of material models for virtual radiography simulations, cylindrical grout specimens were prepared with various weight fractions of PAI. The specimens had a nominal diameter of 15 cm and length of 30 cm. The base cementitious grout material, hereafter denoted as CG, consisted of a cementitious, non-metallic, non-shrink, fluid grout mix suitable for post-tensioning applications.

Three candidate PAI materials were investigated in the study, all in the delivery form of a fine powder: (a) iron (Fe), (b) barium carbonate (BaCO₃), and (c) barium sulfate (BaSO₄). For each PAI material, two concentrations (5% and 15% of the total weight) were used. The specimens were batched under controlled settings using a consistent water-to-grout ratio of 23% (excluding PAI). Material composition for the specimens is summarized in Table 1. The specimens were wet cured for 3 days, and then air dried for 21 days prior to imaging. X-ray diffraction (XRD) analyses of the constituent materials were used to quantify elemental composition (Table 2). This information links material chemistry to radiation attenuation characteristics, and relates to the virtual radiography material models described in Example 2.

TABLE 1
Grout Specimen Composition

| | Composition by Weight | | | | | |
|---|---|---|---|---|---|---|
| | Cemen- | | PAI Material | | | |
| | titious | | Iron | Barium | Barium | Density |
| ID | Grout | Water | Powder | Carbonate | Sulfate | (g/cm³) |
| CG | 81.5% | 18.5% | — | — | — | 1.94 |
| 5% Fe | 77.4% | 17.6% | 5% | — | — | 2.00 |
| 15% Fe | 69.2% | 15.8% | 15% | — | — | 2.11 |
| 5% BaCO₃ | 77.4% | 17.6% | — | 5% | — | 1.96 |
| 15% BaCO₃ | 69.2% | 15.8% | — | 15% | — | 2.05 |
| 5% BaSO₄ | 77.4% | 17.6% | — | — | 5% | 1.93 |
| 15% BaSO₄ | 69.2% | 15.8% | — | — | 15% | 2.01 |

TABLE 2
Elemental Composition of Grout and PAI Materials
Based on X-Ray Diffraction Analysis

| | | Percent by Weight | | | | |
|---|---|---|---|---|---|---|
| | | Cementitious | Iron | Barium | Barium | |
| Element | | Grout | Powder | Carbonate | Sulfate | Water* |
| Aluminum | Al | 1.61% | — | — | — | — |
| Barium | Ba | — | — | 69.59% | 58.84% | |
| Calcium | Ca | 19.48% | — | — | — | — |
| Carbon | C | — | — | 6.09% | — | — |
| Hydrogen | H | — | — | — | — | 11.21% |
| Iron | Fe | 1.20% | 99.43% | — | — | — |
| Magnesium | Mg | 0.79% | — | — | — | — |
| Manganese | Mn | 0.02% | — | — | — | — |
| Oxygen | O | 45.73% | 0.57% | 24.32% | 27.42% | 88.79% |
| Phosphorus | P | 0.03% | — | — | — | — |
| Potassium | K | 0.32% | — | — | — | — |
| Silicon | Si | 29.28% | — | — | — | — |
| Sodium | Na | 0.18% | — | — | — | — |
| Strontium | Sr | 0.00% | — | — | — | — |
| Sulfur | S | 1.27% | — | — | 13.74% | — |
| Titanium | Ti | 0.10% | — | — | — | — |

*Representative elemental composition

TABLE 3
Elemental Composition for PC Concrete Based on X-Ray Diffraction Analysis

| | | Percent by Weight | | | | | | |
|---|---|---|---|---|---|---|---|---|
| | | Cement | Fine | No 57 | No 8 | | | |
| | | (IS40) | Aggregate* | Stone* | Stone* | Water** | Air** | |
| Element | | (18.7%) | (28.2%) | (28.0%) | (18.8%) | (6.3%) | (<0.001%) | Total |
| Aluminum | Al | 4.04% | 0.29% | 10.03% | 10.02% | — | — | 5.53% |
| Argon | Ar | — | — | — | — | — | 0.93% | 0.00% |
| Calcium | Ca | 39.07% | 0.99% | 3.46% | 3.26% | — | — | 9.18% |
| Carbon | C | — | — | — | — | — | 0.01% | 0.00% |
| Hydrogen | H | — | — | — | — | 11.21% | — | 0.70% |
| Iron | Fe | 1.32% | 0.35% | 5.61% | 5.84% | — | — | 3.01% |
| Magnesium | Mg | 3.48% | 0.09% | 2.67% | 2.46% | — | — | 1.89% |
| Manganese | Mn | 0.11% | — | 0.08% | 0.10% | — | — | 0.06% |
| Nitrogen | N | — | — | — | — | — | 78.09% | 0.00% |
| Oxygen | O | 37.72% | 52.67% | 45.41% | 45.54% | 88.79% | 20.97% | 48.77% |
| Phosphorus | P | 0.07% | — | 0.08% | 0.07% | — | — | 0.05% |
| Potassium | K | 0.73% | 0.03% | 3.77% | 3.27% | — | — | 1.81% |
| Silicon | Si | 11.84% | 45.26% | 25.06% | 25.29% | — | — | 26.75% |
| Sodium | Na | 0.11% | 0.08% | 3.27% | 3.63% | — | — | 1.64% |
| Strontium | Sr | 0.17% | 0.04% | 0.07% | 0.04% | — | — | 0.07% |
| Sulfur | S | 1.13% | 0.09% | 0.004% | — | — | — | 0.24% |
| Titanium | Ti | 0.20% | 0.11% | 0.46% | 0.47% | — | — | 0.29% |

*Saturated surface dry (SSD);
**Representative elemental composition

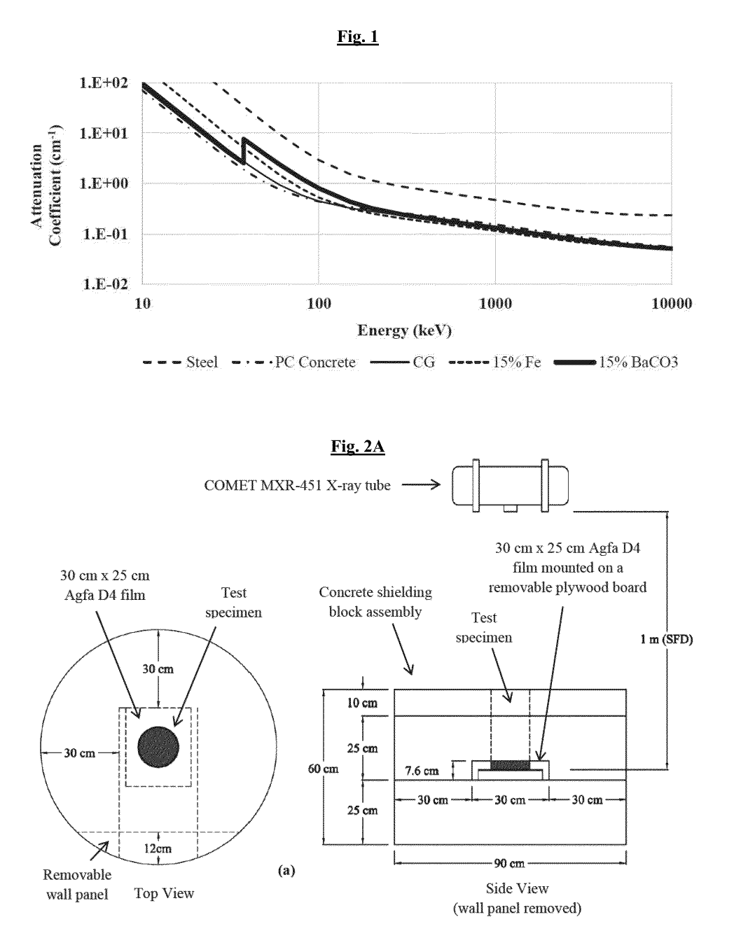

Barium has a K-edge around 37 keV. Near this energy level, there is a sudden increase in photoelectric absorption of photons just above the binding energy of the K shell electrons. As illustrated in FIG. 1, this sudden increase in attenuation at the K-edge has a significant influence on the attenuation spectrum between 37-300 keV. Iron has a K-edge around 7 keV and therefore impacts attenuation over a lower energy region of the spectrum, much of which is effectively filtered out during imaging of thicker structural concrete sections.

At higher energy levels, such as those employed by MeV X-ray betatrons (1-9 MeV), attenuation in all materials is relatively low and mainly due to Compton scattering, i.e., the influence of photoelectric absorption is significantly reduced. For high Z elements (e.g., barium), however, a second form of attenuation in this higher energy region of the emission spectrum known as pair production becomes significant. The probability of pair production increases with photon energy and atomic number of the element interacting with the photon. As a result, high Z elements exhibit significantly different attenuation characteristics below or near the pair production threshold energy of 1.02 MeV than they do at energy levels well above this threshold. As shown in Example 4, this change in attenuation characteristics around the pair production threshold can be used to identify and quantify high Z materials (e.g., PAI grouts) through dual energy radiography.

1.2. Radiographic Imaging

Radiographic imaging of the specimens was performed at an industrial radiography facility using a 450 keV bipolar COMET MXR-451 X-ray tube with a tungsten anode (target angle of 30 degrees) and a 2.3 mm Fe/1 mm Cu filter, which was housed within a 6 m×6 m inspection vault. In certain embodiments, film-based radiography provided absolute measurements of radiation exposure (though changes in film optical density), as opposed to the relative measurements obtained through computed radiography. Agfa Structurix D4 film, an extra fine grain film with a high signal-to-noise ratio and high contrast, was used for all of the images.

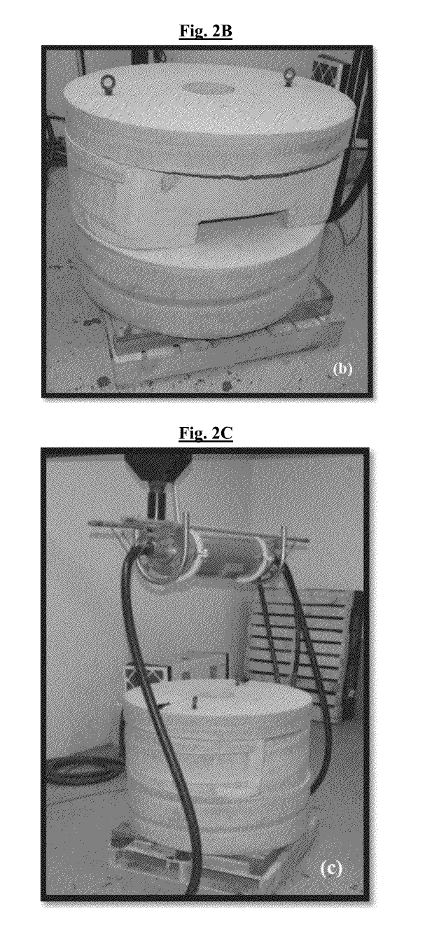

The test configuration for the study is illustrated in FIG. 2. In order to minimize the effect of secondary scattered radiation (i.e., non-incident radiation reflected back into the specimen and film from the inspection vault boundaries, as well as from objects within the vault), the specimens were housed in a specially designed 90 cm diameter concrete shielding block assembly that provided 30 cm of concrete cover along the side and bottom surfaces of the specimen. The circular opening in the shielding block assembly (illustrated in FIG. 2B) was slightly oversized in order to easily lower the cylinder specimens into place and then extract them after imaging. The measured gap between an installed cylinder and the interior shielding block wall was less than 4 mm. As illustrated in FIG. 2B, the assembly was constructed with a removable wall panel in order to position and extract the radiographic film.

In order to evaluate radiation attenuation for a consistent X-ray source, all specimens were imaged at 350 keV-12.85 mA for 480 s, using a source to film distance (SFD) of 1 m. Optical density measurements of the developed film were performed using an X-RITE Model 301 densitometer. The measurements were taken along the diameter of the cylinder at 15 mm increments from the center, designated as the origin for the optical density plots presented in this paper.

1.3. Shielding of Secondary Scattered Radiation

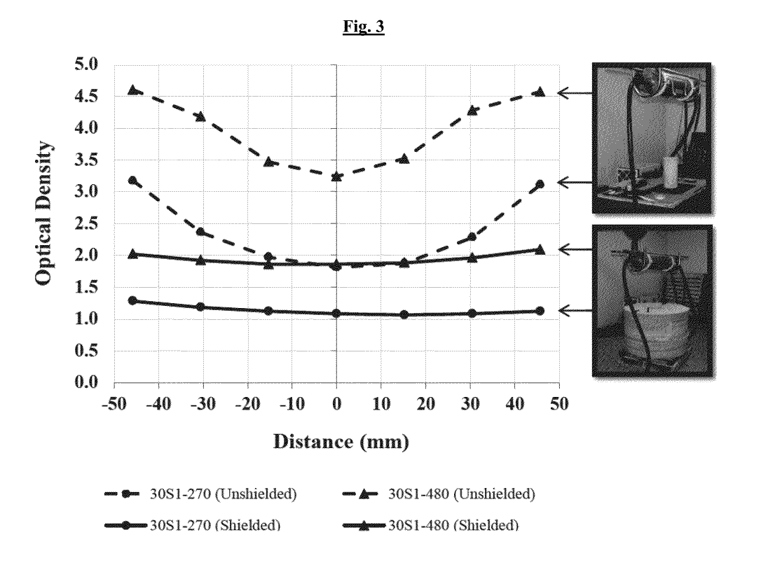

As an illustration of the effect of secondary scattered radiation and the role of the shielding block assembly, FIG. 3 presents optical density measurements for 15 cm diameter×30 cm thick Portland cement (PC) concrete specimens with shielding and without shielding. As noted previously, the optical density measurements were oriented along the diameter of the cylinder with the origin at the cylinder center, and each data set was representative of an image generated for a specified exposure. The image identification numbers presented in the figure are comprised of the specimen thickness (cm), a unique specimen identification number (e.g., S1), and the exposure time (s).

Comparison of optical density measurements between the unshielded and shielded images led to certain observations. In one aspect, the measurement profiles for the unshielded specimens showed a significant increase in radiation intensity toward the perimeter of the specimen, while the profiles for the shielded specimens were relatively flat (uniform intensity distribution). In another aspect, the transmission times associated with a particular target optical density measurement were significantly lower for the unshielded specimens. Without wishing to be limited by any theory, both of these observations are believed to be explained by secondary scattered radiation corruption of the unshielded images. This non-incident radiation, reflected back into the specimen and film from the vault boundaries, intensifies film exposure, particularly near the boundaries of the specimen. Since secondary scattered radiation is influenced by the geometric boundaries of the test environment, which introduces additional experimental variability, the shielding block assembly was employed to reduce this form of image corruption.

1.4. Radiation Attenuation in Conventional and PAI Grout Specimens

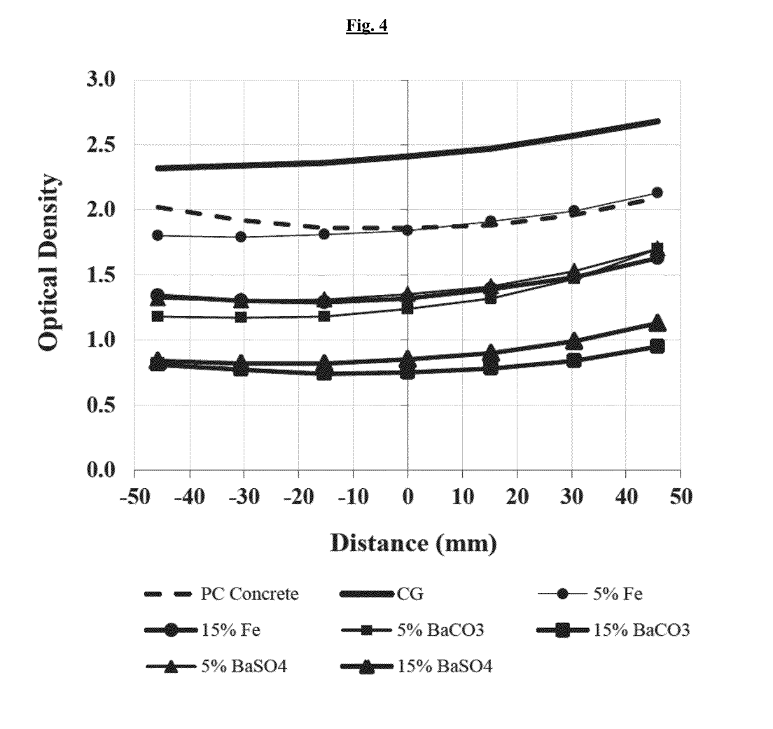

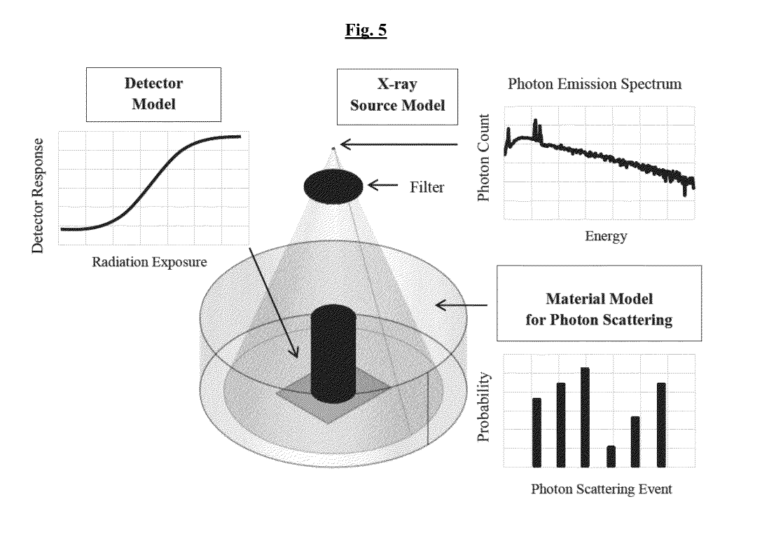

Optical density measurements of the radiographic images generated for the conventional and PAI grout specimens are illustrated in FIG. 4, along with an additional measurement for a PC concrete specimen imaged at the same settings. In general, the measurements for each grout specimen are relatively consistent across the diameter, indicating that radiation attenuation through the thickness of the material produces a relatively uniform spatial distribution of radiation intensity at the detector. Without wishing to be limited by any theory, this observation is believed to be explained by photon scattering in the test assembly, and also appears to indicate relatively good PAI dispersion in the specimens. Using the center point measurement for comparison, the reference optical density measurement for the conventional grout specimen was 2.41. Center point measurements for the 5% and 15% Fe specimens were 1.84 and 1.32, respectively, which correspond to relative reductions in film response (indicative of an increase in radiation attenuation) of 24% and 45%. The barium compound grout specimens were shown to be even stronger attenuators with center point optical density measurements of 1.24 (49% reduction) and 1.35 (44% reduction) for the 5% BaCO₃ and BaSO₄ specimens, respectively, and 0.75 (69% reduction) and 0.85 (65% reduction) for the 15% BaCO₃ and BaSO₄ specimens.

The optical density measurements in FIG. 4 demonstrate that radiation attenuation in cementitious grout can be significantly increased with iron and barium inclusions. For detection of the post-tensioned concrete construction grout void, as discussed elsewhere herein, this augmentation of radiation attenuation can be used to differentiate the grout from the surrounding concrete in a radiographic image. As an example, for the 350 keV X-ray source used in the study, the 15% barium compound grouts provided a 74% increase in the differential between film response for grout and concrete specimen images. In addition, with the exception of the 5% Fe grout specimen, the PAI grouts investigated in the study were higher attenuators than a representative PC concrete. In certain embodiments, this transition to a higher attenuating material is beneficial for high energy X-ray imaging since the higher attenuating materials are visualized with greater clarity while variations in the lower attenuation materials become less discernible.

Table 4 presents the center point measurements from the experimental data shown in FIG. 4 and the relative change in attenuation from the baseline (conventional) grout mix.

TABLE 4
Experimental Optical Density Measurements for the Conventional and
PAI Grout Specimens (350 keV, 480 s)

| | | Relative Change in Film Response |
|---|---|---|
| Specimen ID | Optical Density | with Reference to CG (%) |
| CG | 2.41 | — |
| 5% Fe | 1.84 | 24 |
| 15% Fe | 1.32 | 45 |
| 5% BaCO₃ | 1.24 | 49 |
| 15% BaCO₃ | 0.75 | 69 |
| 5% BaSO₄ | 1.35 | 44 |
| 15% BaSO₄ | 0.85 | 65 |

### Example 2

### Virtual Radiography Model

In order to evaluate the effect of the candidate PAI materials at higher energy X-ray emission levels, and to evaluate the use of PAI to detect grout void detection in post-tensioned concrete construction, virtual radiography simulations were performed using the CIVA RT software.

The software employs two computational algorithms for simulating the propagation of electromagnetic waves through homogeneous and heterogeneous materials: (1) a ray tracing model that uses the Beer-Lambert attenuation law applied along the straight line between the source and the detector, and (2) a Monte Carlo photon scattering model that accounts for Compton, Rayleigh, and photoelectric interaction, as well as pair creation. The resulting images from the companion simulations are then merged by scaling the intensity markers at each pixel in the scattered radiation image so that the total absorbed energy equals that of the ray tracing (direct attenuation) simulation.

The numerical modeling approach employed by CIVA RT utilizes two independent solvers to calculate radiation transmission through the specimen, considering direct and scattered radiation, respectively. This dual solver approach provides a computationally efficient algorithm for modeling radiation transmission through the specimen, without the need to model each individual photon.

An overview of the modeling approach for each solver is provided in the following sections, along with a description of the X-ray source, radiation detector, and specimen material models. For illustration purposes, a conceptual rendering of the virtual radiography model is presented in FIG. 6.

2.1. X-Ray Source Model

The X-ray source is defined by a photon emission spectrum (number of photons emitted for each energy channel) emanating from a discrete point or over a specified focal area. The emission spectrum can be user defined from measured data, developed using a semi-empirical model based on the tube configuration (e.g., anode material, target orientation, and acceleration voltage), or can be selected from a pre-loaded library of emission spectra for transmission and reflection-type X-ray generators. For numerical implementation, the photon emission spectrum is discretized into energy channel bins, each with an associated energy level and photon count. Filtration is modeled either analytically through the emission spectrum module, or explicitly by constructing physical representations of the filter materials (as depicted in FIG. 5).

2.2. Specimen Material Model

The modeling approach can handle homogeneous materials (one user defined material volume) or multi-material composites (multiple user defined material volumes). Each user defined material volume is modeled using a homogenized material approach. First, the volume is spatially discretized into an analytical mesh of material points based on a user specified mesh density (typical distance between adjacent material points). Proper specification of mesh density requires a numerical convergence analysis or validation of the model with benchmark experimental data. Each material point has an associated elemental composition based on the weight fraction of elements or chemical compounds. The elemental data at each material point is stored in look-up tables that characterize the probability of encountering a particular element at a specific location in the specimen. This probabilistic material model is an essential component of the Monte Carlo photon scattering simulation that is discussed elsewhere herein.

2.3. Beer-Lambert Solver for Direct Radiation

The first solver executed in the virtual radiography simulation calculates direct radiation in accordance with the Beer-Lambert law, which defines a relationship between the number of photons emitted at a particular energy level and the fraction of those emitted photons that are transmitted through the material, reaching the detector on the opposing surface.

Nₜ=Nᵢ. exp(−μ.L) (1)

In Equation (1), μ is an attenuation coefficient that depends on the material composition and the photon emission energy, and L is the straight line distance that the photon travels though the specimen from the source to a particular location on the surface of the detector. L is a measurable parameter based on both the specimen geometry and the test configuration. For the attenuation parameter μ, attenuation coefficient spectra (attenuation as a function of photon energy) for chemical elements, compounds, and mixtures are provided in the literature (Hubbel & Seltzer, 1996, Tables of X-Ray Mass Attenuation Coefficients and Mass Energy-Absorption Coefficients, NISTIR 5632, National Institute of Standards and Technology).

For each energy channel in the photon emission spectrum, a virtual radiograph is generated in accordance with (1) and the associated detector model. The channel-specific radiographs are then combined to form the final direct radiation radiograph. For the discrete point X-ray source model, geometric blurring is modeled assuming a Gaussian distribution. The typical dimension used by the geometric blurring model corresponds to the true focal dimension of the X-ray tube multiplied by a medium magnification factor.

2.4. Monte Carlo Scattered Radiation Solver

The second solver models radiation scattering in the specimen using a Monte Carlo simulation. In this approach, scattering event probability is assigned to the spatially distributed material points. In addition to the probability associated with encountering a particular element, the photon collision processes associated with that element and the incident photon energy (i.e., photoelectric absorption, Compton scattering, Thomson scattering, or pair creation) are also assigned a probability of occurrence. During the simulation, individual photons move through the specimen, to and from material points, in a random walk process, starting at the point of intersection between the idealized straight line photon trajectory and the exposed surface of the specimen. At each material point, a particular collision process is modeled, based on the assumed event probability. The modeling scheme employed for each scattering process is summarized herein. The Monte Carlo photon scattering code in CIVA RT is parallelized for efficient implementation on multi-core/multi-processor workstations.

Photoelectric Absorption

Photoelectric absorption occurs when a photon is absorbed by an atom, resulting in the ejection of electrons from the outer shell. The ionized atom returns to a neutral state by emitting an X-ray characteristic to the atom type. This X-ray emission is low energy, relative to the energy of the incident photon, and generally does not contribute to the resulting radiograph. Photoelectric absorption is the dominate process for X-ray absorption up to energies of about 500 keV and for atoms with high atomic numbers. In the virtual radiography model, a photoelectric absorption event results in the termination of the random walk simulation for the photon.

Compton Scattering

Compton (or incoherent) scattering is an inelastic collision between a photon and an electron. The photon loses energy due to the interaction but continues to travel through the material along an altered path. In the virtual radiography model, Compton scattering is modeled by the Klein-Nishina formula, as defined in (2).

$$\frac{{E}_{θ}}{{E}_{i}} = \frac{1}{1 + ( {E}_{i} / {m}_{e} {c}^{2} ) ( 1 - cos θ )} \qquad ( 2 )$$

In Equation (2), Eᵢ and E_{θ} are the photon energy before and after collision, respectively; mₑ is the mass of an electron (˜511 keV/c²); c is the speed of light (˜3 . 10⁸ m/s); and θ is the scattering angle. For low energy photons (<100 keV), the impact of electron binding energy on angular distribution is significant, and a correction factor (taking atomic number into account) is applied to the Klein-Nishina prediction.

Thomson Scattering

Thomson scattering (also known as Rayleigh, coherent, or classical scattering) is an elastic interaction between a photon and an atom. After collision, the trajectory of the photon is changed without alteration of the photon energy. This type of interaction occurs for photon energy levels lower than 200 keV. The change in photon trajectory is governed by the differential Thomson scattering cross section defined in (3).

$$\frac{d {σ}_{t}}{d Ω} = ( \frac{{q}^{2}}{{m}_{e} {c}^{2}} ) \frac{1 + {cos}^{2} θ}{2} \qquad ( 3 )$$

In Equation (3), σₜ is the Thomson cross section, ω is the solid angle between wavelengths, and q is the charge per particle.

Pair Creation

Pair creation occurs when an electron and positron are created by the annihilation of the photon. This interaction can occur when photon energy is greater than 1.02 MeV, but generally becomes significant around 5-6 MeV. CIVA RT models the annihilation of the photon by terminating the random walk. At higher energy levels (above 5-6 MeV), Bremsstrahlung (secondary) radiation involving the newly created position becomes important. Bremsstrahlung radiation is not modeled in the CIVA RT scattered radiation code, limiting the physical validity of the software to photon energies around 5-6 MeV.

2.5. Radiation Detector Model

The radiation detector model defines the relationship between detector response and radiation exposure. For photostimulable film, radiation exposure across the emulsion-gelatin coating liberates ions from suspended silver halide crystals. The liberated ions form new compounds that are sensitive to the chemical solution applied during film development. The ensuing reaction results in the formation of black metallic silver within the gelatin coating, the concentration and distribution of which are affected by (and indicative of) radiation exposure. Optical density measurements of the developed film, which express the relationship between light transmitted through the film to the incident intensity from a light source, can be used to quantitatively measure radiation exposure. This exposure-response relationship for a particular detector, including measurement resolution, is published by the manufacturer, and is readily incorporated in the numerical modeling scheme. An illustration of a representative exposure-response curve for radiographic film is shown in FIG. 5.

Numerical implementation of the detector model is based on the following approach. First, the probability for each photon reaching the detector to interact with the photostimulable detector layer is computed using (4).

probᵢ=exp(−μ_{df}L_{df})(1−exp(−μ_{d}L_{d})) (4)

In Equation (4), μ_{d} and μ_{df} are the linear photon attenuation coefficients for the photostimulable detector layer and detector filter, respectively; L_{d} and L_{df} and are the associated thicknesses. Then, the amount of energy deposited in (or absorbed by) the photostimulable detector layer (E_{dep}) is calculated according to (5).

$${E}_{dep} = \frac{{σ}_{abs} {E}_{id}}{{σ}_{tot} {E}_{id}} {prob}_{i} {E}_{i} \qquad ( 5 )$$

In Equation (5), E_{id} is the energy of the incident photon as it reaches the detector, and σ_{abs} and σₜₒₜ are the energy absorption coefficients, coming from Storm-Israel tables, for the photostimulable detector layer and the combined effect of the detector filter and photostimulable layers. The absorbed energy is then transformed into a signal based on the exposure-response relationship for the particular detector, defined by (6).

signal=GE_{dep} (6)

In Equation (6), G is the global gain. For commonly used radiographic film, the relationship in (6) relates radiation dosage to optical density, and is standardized by EN584 [11, 12].

Detector noise, which is separate from the geometric blurring effects discussed elsewhere herein, is also considered in the simulation. For EN584 standard film, the modeling approach assumes that detector noise (σ″), or granularity, is roughly proportional to the square root of D/2, where D is the predicted optical density measurement from (6).

$${σ}^{″} = {σ}_{D} \sqrt{\frac{π \cdot 10000}{4 A}} \sqrt{\frac{D}{2}} \qquad ( 7 )$$

In Equation (7), A is the aperture area in μm². Detector noise can then be used to generate uniformly distributed noise around D.

2.6. Image Generation

The final virtual radiograph is developed by combining results from the Beer-Lambert direct radiation solver and the Monte Carlo scattered radiation solver. A schematic illustration of the procedure is shown in FIG. 6. The direct radiation simulation is performed first. This simulation generates an image for the uncollided flux using the actual fluence (number of emitted photons) based on the X-ray source settings (N_{uf}). As noted elsewhere herein, the direct radiation simulation takes geometric blurring into account. The spatial distribution of photon energy reaching the surface of the detector is calculated and defined as the uncollided flux image (UF(x,y)), where x and y define a unique point along the detector surface in Cartesian coordinates. Then, two uncorrelated Monte Carlo simulations are performed, each using a fluence equal to half of the user specified number of photons (N_{sf}), which is generally significantly lower than the number of photons considered in the direct radiation simulation. The energy reaching the detector surface in the two scattered radiation simulations is combined to obtain the unscaled scattered flux image (SF_{unscaled}(x,y)). Using a digital filter (e.g., Hanning or Butterworth), the unscaled scattered flux image is then decomposed into an idealized (noise free) scattered flux image (SF_{unscaled}^{ideal}(x, y)) and an associated noise component (SF_{unscaled}^{noise}(x, y)). The idealized scattered flux image and associated noise component are then scaled up to the uncollided flux image using a normalization factor equal to the ratio of N_{uf} to N_{sf}. The resulting scaled idealized scattered flux image (SF_{scaled}^{ideal}(x, y)) is added to the scaled noise component (SF_{scaled}^{noise}(x, y)) to form the scaled scattered flux image (SF_{scaled}(x, y)). The scaled scattered flux image is then added to the uncollided flux image to generate the total flux image (TF(x,y)), which contains the spatial distribution of photon energy at the surface of the detector. This information is used as input for the detector model to compute the final virtual radiograph (VR(x,y)), which contains the spatial distribution of detector response (e.g., optical density readings for radiographic film).

2.7. Model Validation for Imaging of PAI Grouts

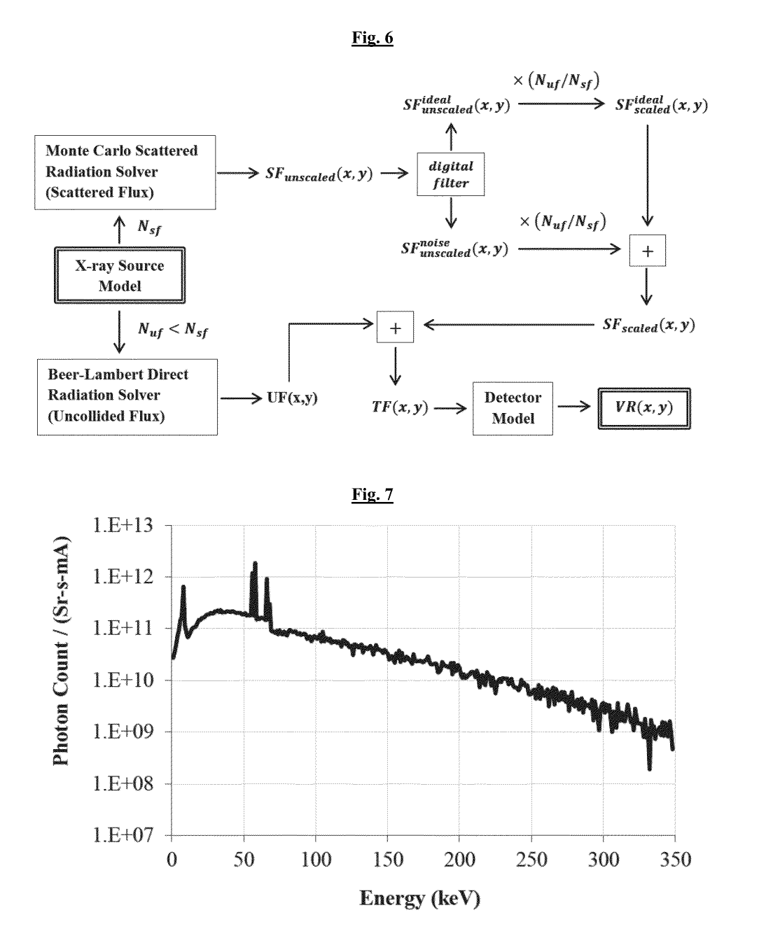

The numerical model developed for the validation study was similar to the approach shown in FIG. 5. Both the specimen and shielding block assembly were modeled in order to provide a more accurate depiction of photon scattering in the test assembly. For simplicity, the air gap between the specimen and shielding block assembly was neglected, and each component (i.e., the specimen and shielding block assembly) was modeled as a homogenized material with an effective chemistry representative of the true heterogeneous material. Elemental composition for each material was based on the XRD analyses presented in Tables 2-3. Each component of the test assembly was discretized with a 1 mm mesh resolution. The X-ray source was modeled to replicate the COMET MXR-451 X-ray tube and exposure settings utilized for the experimental images. This was accomplished by using the photon emission spectrum shown in FIG. 7, which is pre-loaded in the CIVA RT library and represents a 350 keV transmission-type X-ray generator with a tungsten anode, along with a 2.3 mm Fe/1 mm Cu filter model. The filter was modeled explicitly using the software's flaw module by creating two appropriately sized disks of the associated material, and locating the filter materials between the X-ray source and the specimen. The radiation detector used in the simulations was based on the pre-loaded Agfa D4 film model.

For computational efficiency, the integrated Beer-Lambert direct radiation—Monte Carlo photon scattering simulation was employed, along with a simulation acceleration feature that assumes perfect absorptivity of the detector and reduces the number of virtual photons needed to characterize scattering. For all simulations, 10 billion photons were considered in the scattered radiation simulation. The simulations were run in full physics mode (all photon collision behavior considered) and without a photon energy threshold (early termination of a photon random walk simulation if the energy level falls below the user specified threshold).

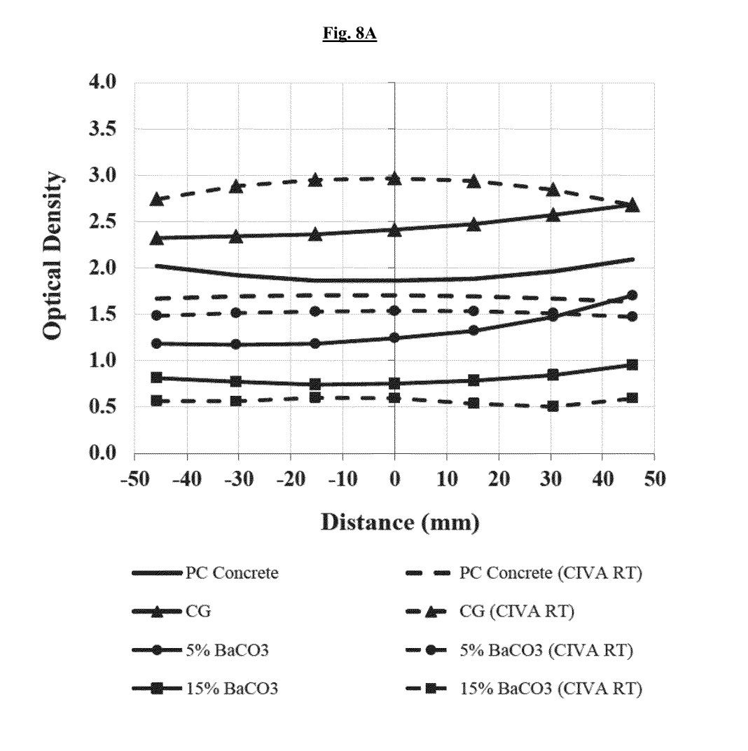

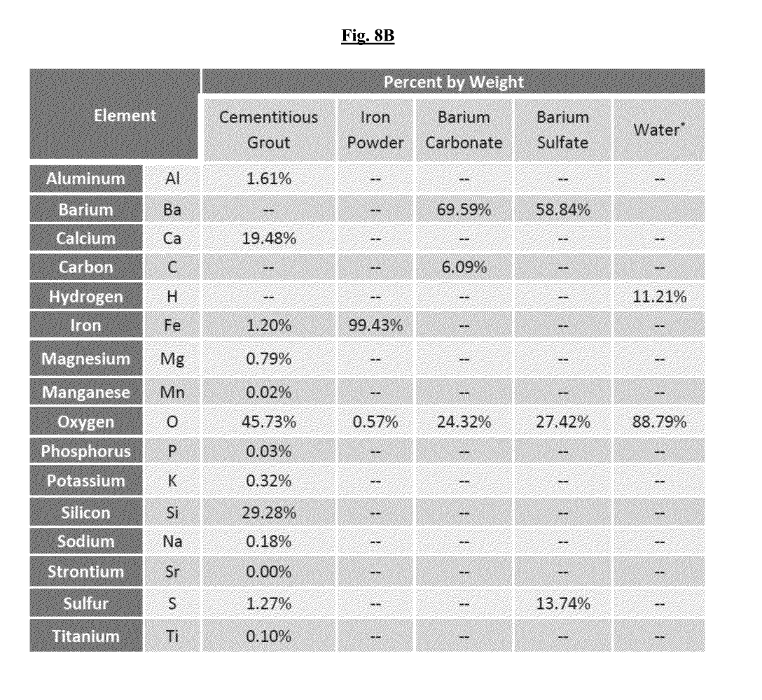

FIG. 8 compares optical density measurements from experimental radiographs of the CG, 5% BaCO₃, and 15% BaCO₃ grout specimens with predictions generated from the virtual radiography model, along with corresponding data for a 30 cm PC concrete specimen. The optical density measurements in the experimental images were relatively constant near the center of the cylinder, but increased steadily toward the perimeter due to enhanced radiation exposure near the air gap in the test assembly. In contrast to the experimental data, the optical density distribution in the virtual radiographs was relatively flat, with slightly lower values near the edges of the cylinder. This characteristic profile was attributed to the absence of the air gap in the numerical model, which (as noted earlier) was done for computational efficiency. The reduction in optical density away from the center point in the virtual radiographs was due to the increase in path length through the material for greater angles of incidence.

For the CG specimen, the predicted optical density measurement at the center point was 2.96, 23% greater than the experimental measurement of 2.41. The virtual radiography simulations for the 5% and 15% BaCO₃ specimens produced optical density measurements of 1.32 and 0.59, respectively, which corresponded to relative differences of 23% and 21% with respect to the experimental measurements. Validation studies for 20 cm and 30 cm thick PC concrete specimens demonstrated that both the experimental and numerical data were highly repeatable for consistent imaging settings, and that numerical predictions for the 30 cm thick specimens were within 4-8% of the experimental data.

Without wishing to be limited by any theory, the error in the model predictions is believed to be largely due to approximation of the photon emission spectrum, particularly the lower energy region of the spectrum that includes the characteristic K-lines. As shown in FIG. 8A, for higher attenuating materials, the absolute error in the numerical prediction was reduced due to filtration of the lower energy content. The lower relative error in the imaged concrete specimens was likely due to greater material homogeneity.

### Example 3

### PAI for Enhancing Grout Void Detection in Post-Tensioned Concrete Construction

3.1. Virtual Radiography Model for a Post-Tensioned Concrete Element

In order to evaluate the use of PAI materials to improve grout void detection in post-tensioned concrete construction, the validated material models from Example 2 were used to develop a virtual radiography model for a 60 cm×60 cm×30 cm thick concrete slab with an embedded post-tensioning tendon. An exemplary rendering of the model is shown in FIG. 9. The model was an idealized representation of a post-tensioned concrete bridge girder web section. The tendon was centered at mid-depth of the section and consisted of a 59 mm interior diameter corrugated polypropylene (PP) duct with a 2.5 mm wall thickness that houses seven 15 mm diameter seven-wire steel strands (idealized as straight, smooth rods). Four grout materials (CG; 5%, 15%, and 30% BaCO₃) and two grout conditions (fully grouted and ungrouted ducts) were investigated in the study.

For continuity with the material validation study, the specimen was first imaged using the 350 keV X-ray source model outlined in Example 2. In order to evaluate the use of PAI with higher energy MeV X-ray inspection equipment, the specimen was then imaged using experimentally measured emission spectra for a portable JME 6 MeV X-ray betatron, considering the two limits of the adjustable voltage setting (2 MeV and 6 MeV). The exposure times for the 2 MeV and 6 MeV spectra were 30 s and 10 s, respectively, designed to produce comparable levels of deposited energy at the detector.

The proposed inspection method for grout void detection in new construction involves in certain embodiments the comparison of images taken before and after grouting operations. The test statistic for quantitatively comparing these images is contrast-to-noise ratio (CNR), defined as the difference between the mean detector response within a region of interest (ROI), normalized by the larger image ROI standard deviation. For generality, radiation energy reaching the detector (not detector response) was used in the present study. Measurements were constrained to a 400 cm² ROI within the projected image of the tendon, as shown in FIG. 9, in order to reduce the influence of the artificial physical boundaries.

The virtual radiography simulations were run using the integrated Beer-Lambert direct radiation—Monte Carlo photon scattering algorithm with a mesh resolution of 1 mm. For the scattered radiation simulation, 10 billion photons were considered. In one aspect, the present simulations demonstrate a potential application for PAI, and provide preliminary data regarding the effect of candidate PAI materials on CNR for a realistic void detection scenario.

3.2. CNR Between Fully Grouted and Ungrouted Tendons

Table 5 presents CNR measurements between fully grouted and ungrouted tendons considering the four grout mix designs (CG and BaCO₃ enhanced), the various weight fractions of PAIS and X-ray emission levels. For the 350 keV emission spectrum, CNR was enhanced by 26%, 40%, and 75%, respectively, for 5%, 15%, and 30% BaCO₃. As discussed in Example 1, the increase in attenuation for the barium compound grouts was due to enhanced photoelectric absorption in the 37-300 keV range. The effect of BaCO₃ was less pronounced for the MeV emission spectra due to the dominance of higher energy photons. In this higher energy region, attenuation coefficients were relatively small and less separated. CNR enhancements of 40% and 33% were found for the 30% BaCO₃ grout for the 2 MeV and 6 MeV images, respectively. Without wishing to be limited by any theory, a narrow band emission spectrum concentrated in the 5-15 MeV range may provide better PAI CNR enhancement in the high energy region by taking advantage of pair production attenuation in high Z materials.

TABLE 5
CNR Between Images of Fully Grouted and Ungrouted Tendon Lengths

Grout Mix

| | | 5% | 15% | 30% |
|---|---|---|---|---|
| X-Ray Source | CG | BaCO₃ | BaCO₃ | BaCO₃ |
| COMET MXR-451 | 5.7 | 7.2 | 8.0 | 10 |
| 350 keV-480 sec | | | | |
| JME 6 MeV Betatron | 5.3 | 5.6 | 6.2 | 7.4 |
| 2 MeV-30 sec | | | | |
| JME 6 MeV Betatron | 2.4 | 2.6 | 3.0 | 3.2 |
| 6 MeV-10 sec | | | | |

### Example 4

### PAI for Material Discrimination in Composite Structures

4.1. Dual Energy Radiography

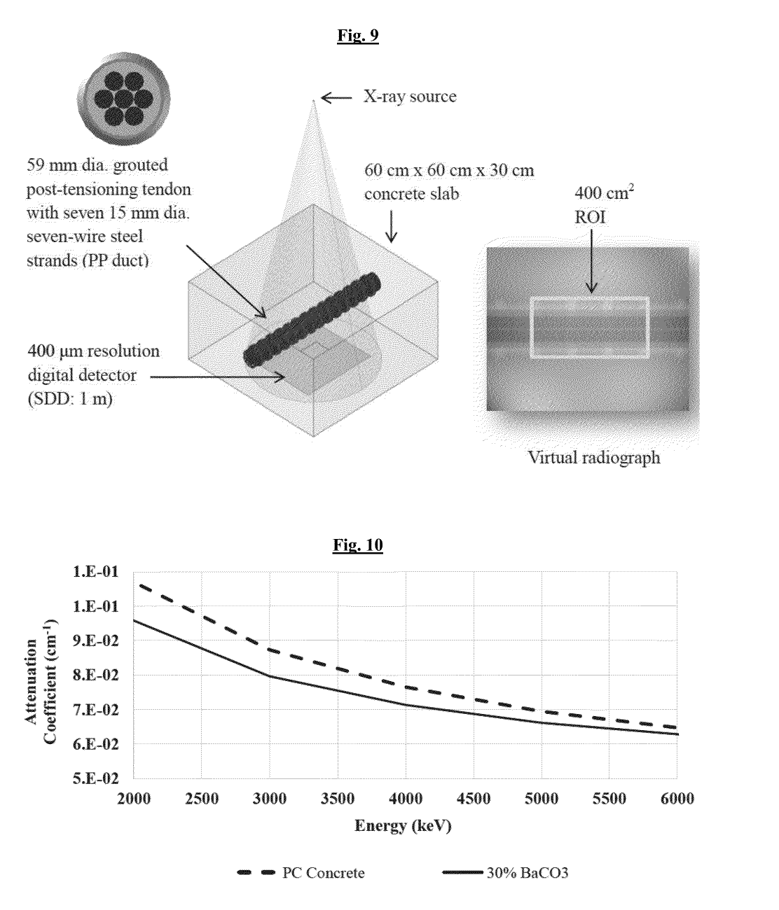

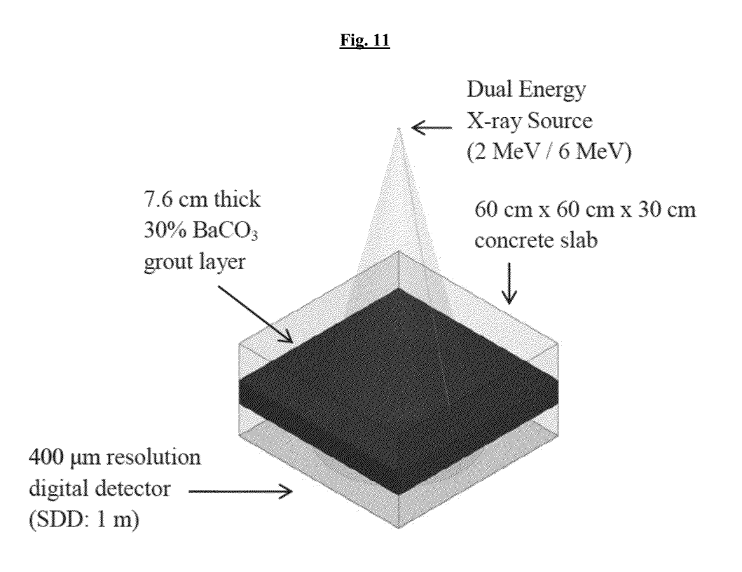

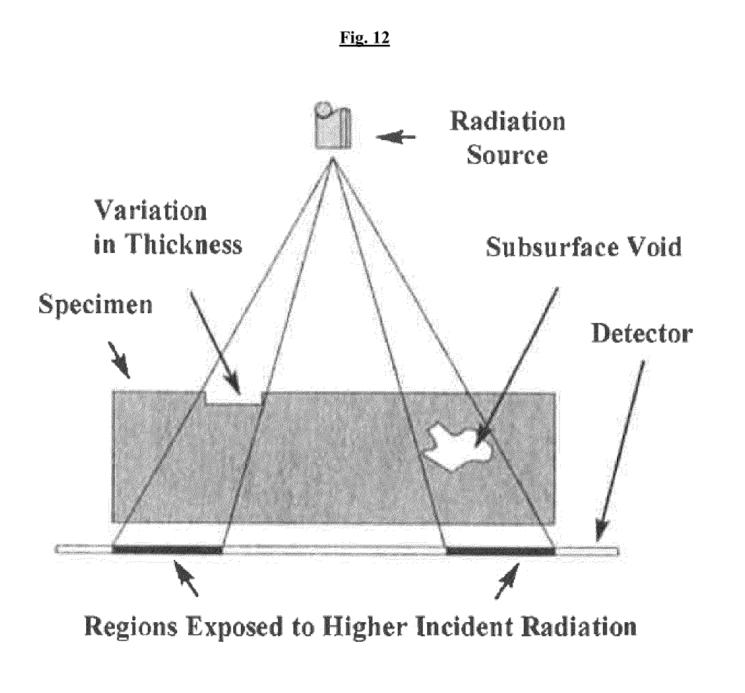

As discussed elsewhere herein, high Z materials, such as barium, are stronger attenuators of high energy photons (well above 1.02 MeV) than low Z materials due to the occurrence of pair production. This means that materials that have similar attenuation coefficients near the pair production threshold may have significantly different attenuation coefficients at energies above the threshold; or in the case of PC concrete and 30% BaCO₃, pair production enhancement for the barium grout brings the attenuation coefficients closer in value in the higher energy range (FIG. 10). As a result, images generated in these two energy regions can be combined using advantageously selected scale factors in order to mathematically suppress materials for enhanced visualization and material quantification. This dual energy imaging process is based on direct radiation (unscattered flux) as defined in Equations (8) and (9), which represent the incident and transmitted intensity, respectively.

Iₒ=∫_{E=0}^{Emax}S(E)·D(E)dE (8)

Iₜ=∫_{E=0}^{Emax}S(E)·D(E)·e^{-μ(E)t} dE (9)

In Equations (8) and (9), S(E) is the continuous X-ray source spectrum and D(E) is the detector sensitivity (both functions of photon energy E), and t is the straight-line distance through the material along a photon path. For the simplified case of a bimaterial composite, (9) becomes the linear combination of two materials (Material 1, Material 2) with effective attenuation coefficients:

Iₜ/Iₒ=e^{-(μ1·t1+μ2·t2)} (10)

Taking the natural log of both sides of (10) yields:

−ln(Iₜ/Iₒ)=μ1·t1+μ2·t2=IMG (11)

Linear combination of low and high energy images (denoted by IMG_{L} and IMG_{H}, respectively) using scale factors k_{L} and k_{H} produces the following relationship:

k_{L}·IMG_{L}+k_{H}·IMG_{H}=t1(k_{L}·μ1_{L}+k_{H}·μ1_{H})+t2(k_{L}·μ2_{L}+k_{H}·μ2_{H}) (12)

The individual materials can then be mathematically suppressed in the combined image by specifying the image scale factors such that the coefficient of the thickness term is zero. For example, setting

k_{H}/k_{L}=−μ1_{L}/μ1_{H} (13)

Material 1 can be mathematically suppressed, leaving the following expression for the thickness of Material 2:

t2=[IMG_{L}+(−μ1_{L}/μ1_{H})·IMG_{H}]·[μ2_{H}+(−μ1_{L}/μ1_{H})·μ2_{H}]⁻¹ (14)

4.2. Dual Energy Radiography Simulation

As an illustrative example of the application of PAI to dual energy radiography, a simple bimaterial composite structure was developed and imaged at two energy levels: (a) 2 MeV (near the pair production threshold), and (b) 6 MeV (where pair production significantly influences attenuation).

The structure, shown in FIG. 11, consists of a 60 cm×60 cm×30 cm thick PC concrete slab with an embedded 7.6 cm thick layer of 30% BaCO₃ grout. For simplicity, the sources were idealized as monochromatic (highly simplified representation of a heavily filtered emission spectrum), considering 100 million photons each. The detector was also assumed to be large enough to receive all of the transmitted energy (60 cm×60 cm for this study). Model parameters and simulation settings were similar to those outlined for the grout void detection simulation.

Simulations were performed to evaluate the effect of scattered radiation on thickness measurement of the BaCO₃ layer, including (1) an idealized Beer-Lambert direct radiation simulation that neglects scattering, and (2) a Monte Carlo photon scattering simulation considering the actual fluence. Since the dual energy approach is based on the uncollided flux (Beer-Lambert law), the thicknesses of the grout and concrete layers were correctly predicted using the Beer-Lambert results, along with the material suppression approach outlined elsewhere herein. Scattering in the Monte Carlo simulation was found to significantly degrade the accuracy of the thickness measurements, indicating that selective filtering or use of a detector that can discriminate between photon energy levels is necessary for dual energy radiographic imaging of specimens were scattered radiation provides a significant contribution.

### Example 5

### Modeling Approach in CIVA RT for Concrete Structures

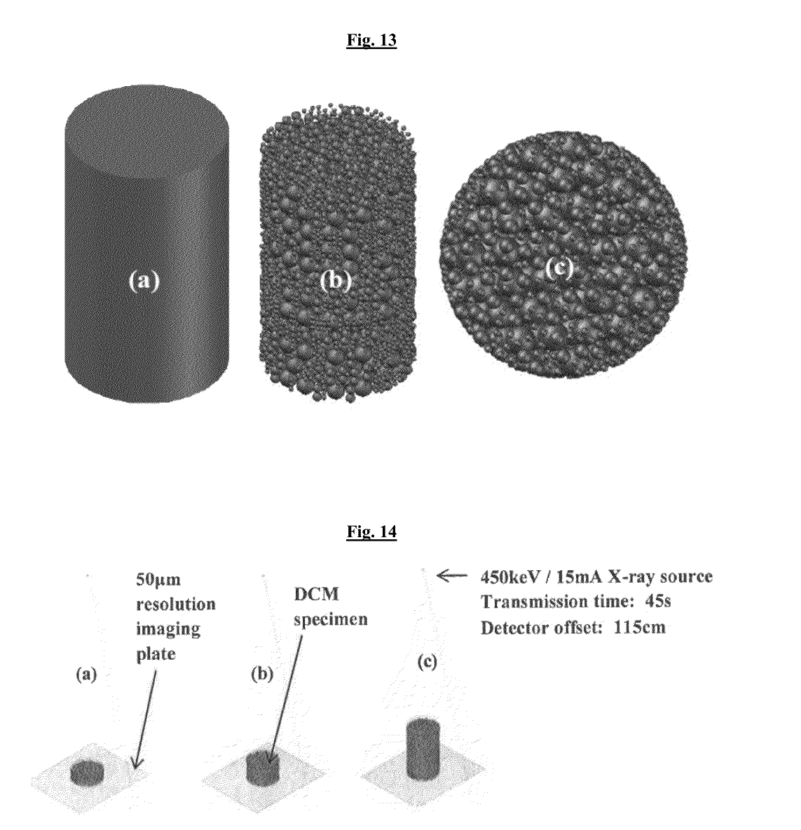

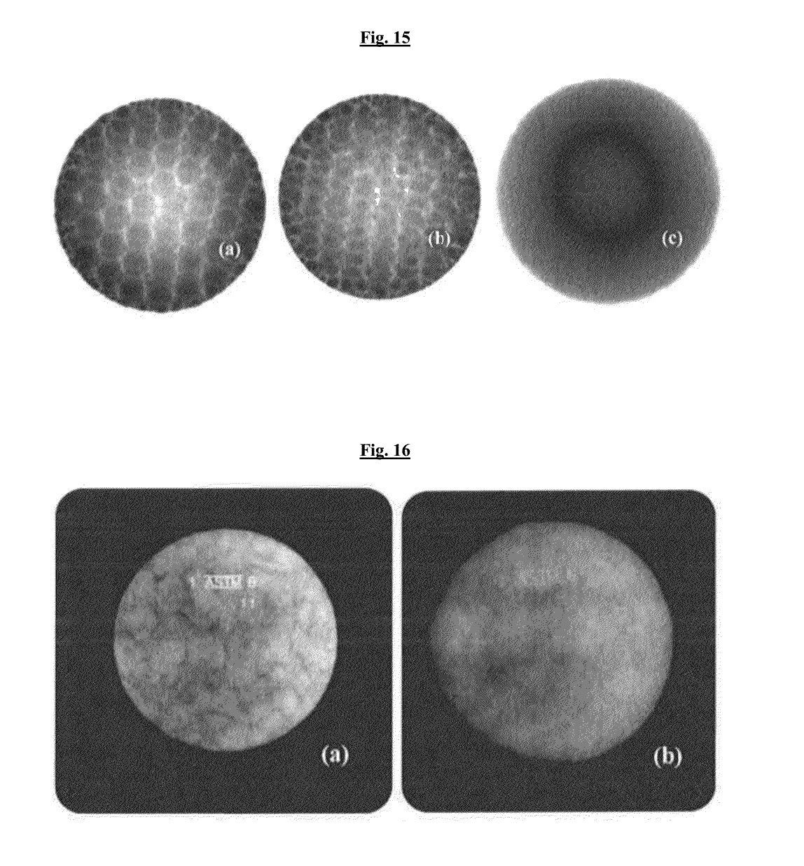

A modeling approach in CIVA RT for concrete structures was developed. Two modeling approaches were investigated for simulating concrete structures: (1) a discrete coarse aggregate concrete model (DCM); and (2) a homogenized concrete model (HCM). In the DCM approach (FIG. 13), the aggregate population and cement mortar matrix were treated as separate homogenized volumes, providing a more realistic distribution of the two major constituent materials (PC mortar and limestone aggregate), particularly for concrete mix designs with lower volumetric fractions of coarse aggregate. The HCM approach provided a more computationally efficient model by resolving the material composition into a fully homogenized “effective” material. In order to determine an approximate aggregate-to-specimen volumetric ratio at which predictions from the HCM and DCM approaches converge, numerical models were developed in CIVA RT for six concrete cylinder specimens: (1) 15 cm diameter×5 cm DCM; (2) 15 cm diameter×10 cm DCM; (3) 15 cm diameter×25 cm DCM; (4) 15 cm diameter×5 cm HCM; (5) 15 cm diameter×10 cm HCM; (6) 15 cm diameter×25 cm HCM. Renderings of the test configurations are presented in FIG. 14. Each specimen was imaged three times in order to measure the inherent test variability (which in the numerical simulation approach is driven by the Monte Carlo photon scattering algorithm).

Virtual radiographs from the study are presented in FIG. 15. In the radiograph for the 5 cm thick cylinder, individual aggregate boundaries were clearly defined. However, as the thickness was increased to 10 cm, the individual boundaries started to become blurred due to increases in photon attenuation and scattering in the system. In the 25 cm thick specimen, individual aggregate boundaries could not be readily detected, resulting in an image that was similar to the corresponding radiograph produced for the HCM approach. This trend was also observed in a series of experimental radiographic tests that were performed on 15 cm diameter concrete cylinders (FIG. 16). In the 5 cm thick specimen, individual aggregate boundaries were clearly defined. However, in a similar manner to the numerical simulations, the aggregate population became blurred at 10 cm due to increased attenuation and scattering of the incident photons.

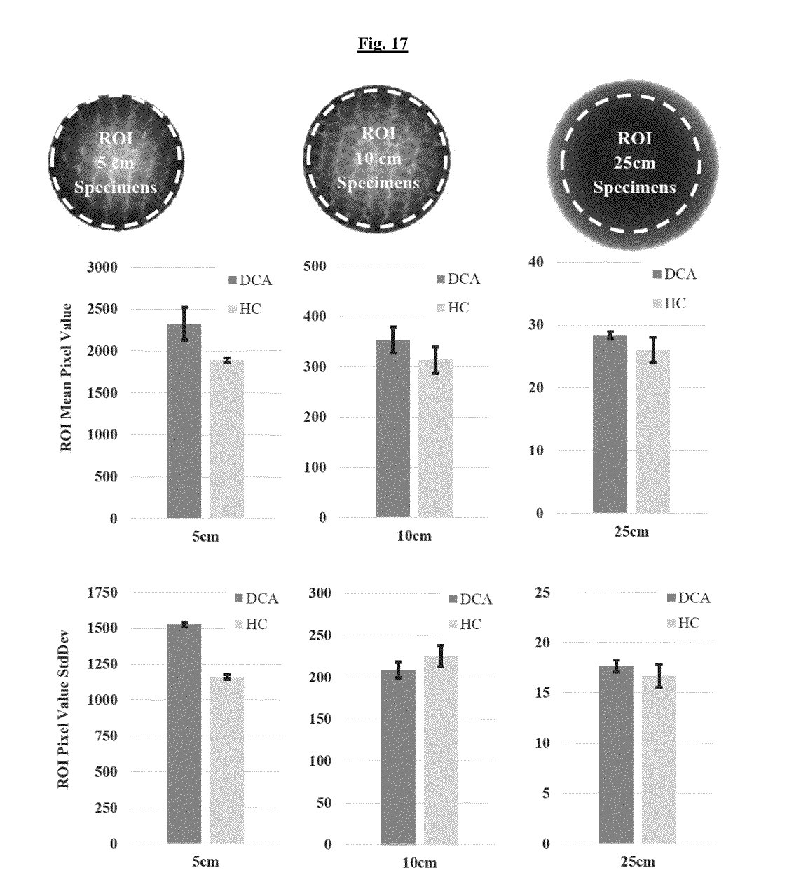

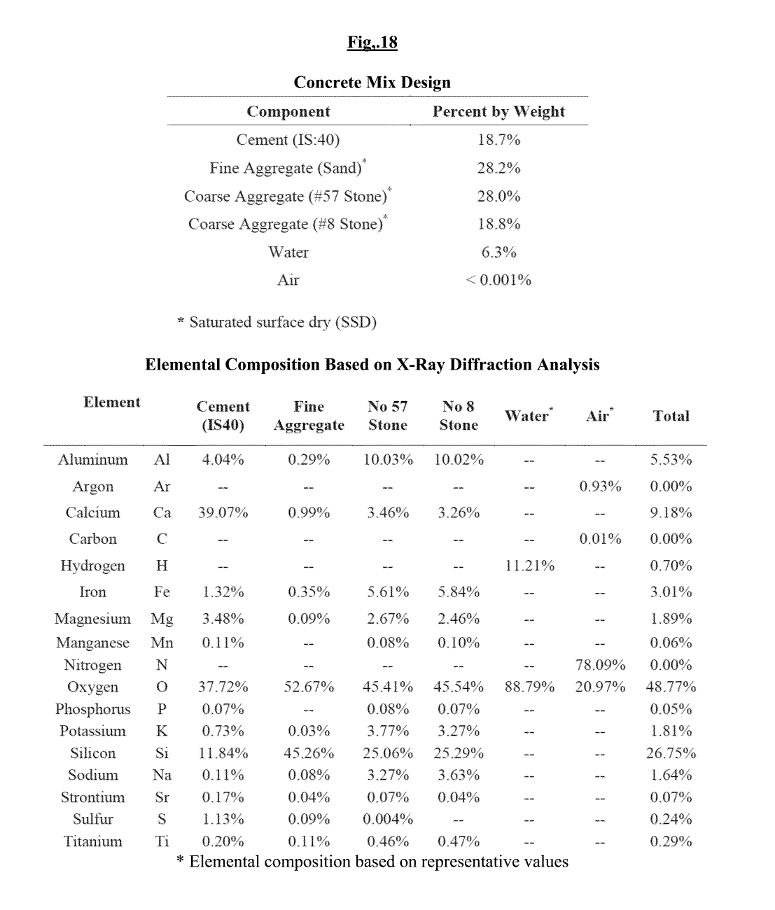

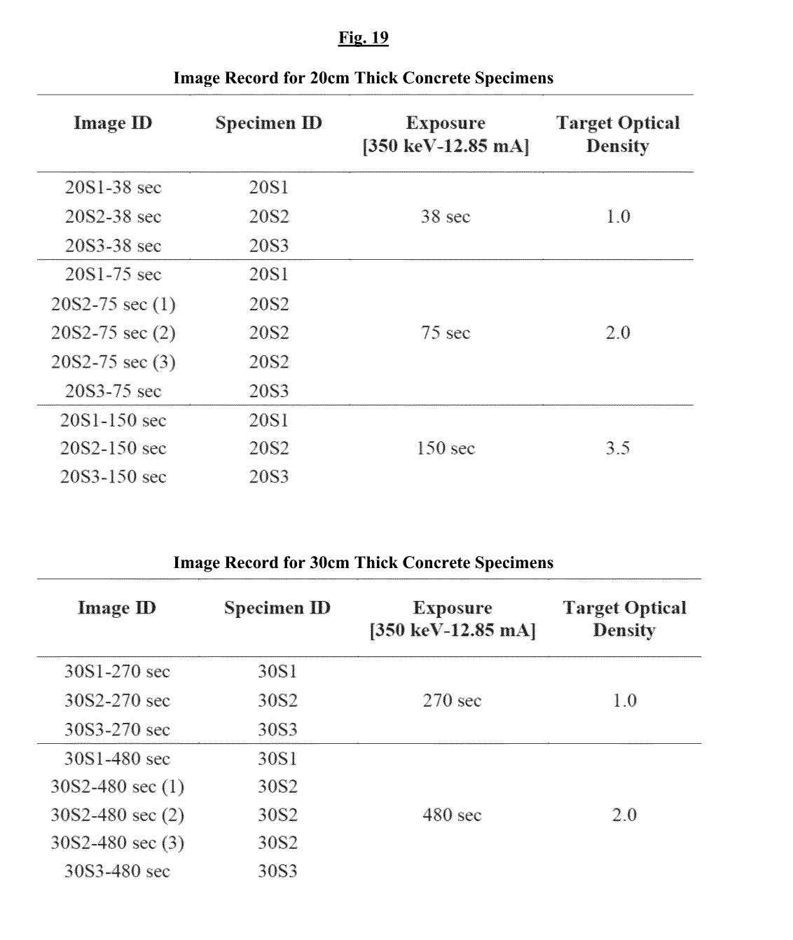

FIG. 17 illustrates the region of interest (ROI) pixel intensity distributions from the virtual radiographic cylinder tests. For the 5 cm thick specimens, the DCM approach produced a higher mean pixel intensity value than the HCM approach, as well as a greater standard deviation of pixel intensity values in the ROI. Without wishing to be limited by any theory, this may be attributed to the localization of the constituent materials (which have different attenuation characteristics). However, for the 10 cm and 25 cm thick specimens, the pixel intensity distribution for the DCM and HCM approaches fall within the inherent test variability. The results from the study indicate that predictions from both approaches are in reasonable agreement when the aggregate-to-specimen volumetric ratio is less than 20%.

A model validation study was performed using the concrete mix illustrated in FIG. 18. PC concrete specimens (20 cm and 30 cm thick) were produced, and a concrete housing assembly was used to reduce secondary scattered radiation. X-ray diffraction (XRD) was used to analyze the constituent materials for elemental compositions (FIG. 18).

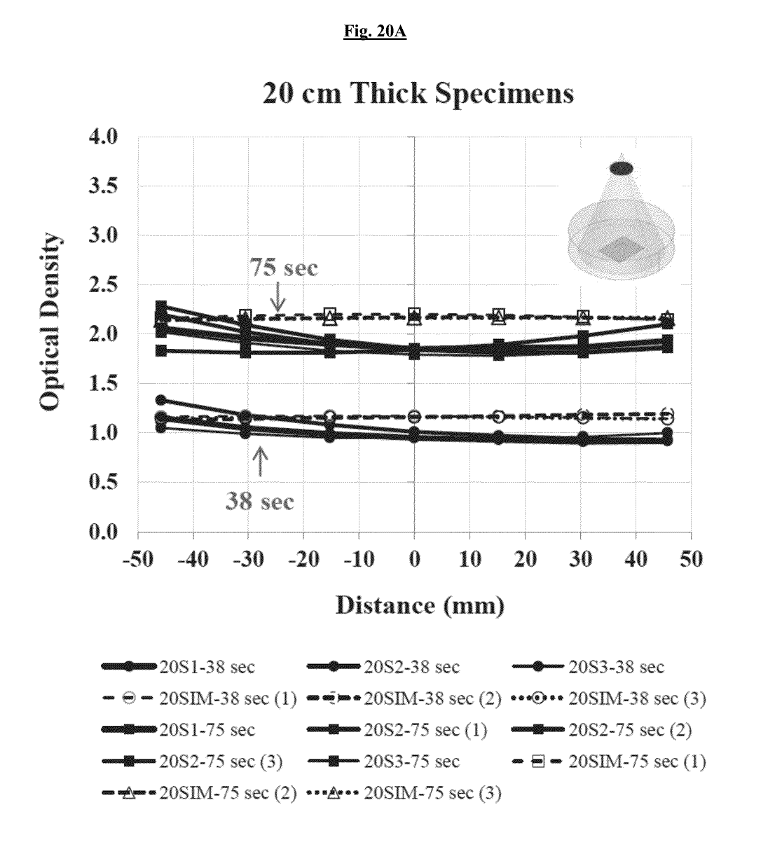

FIG. 19 comprises a set of tables illustrating measurements obtained for experimental images obtained for model validation.

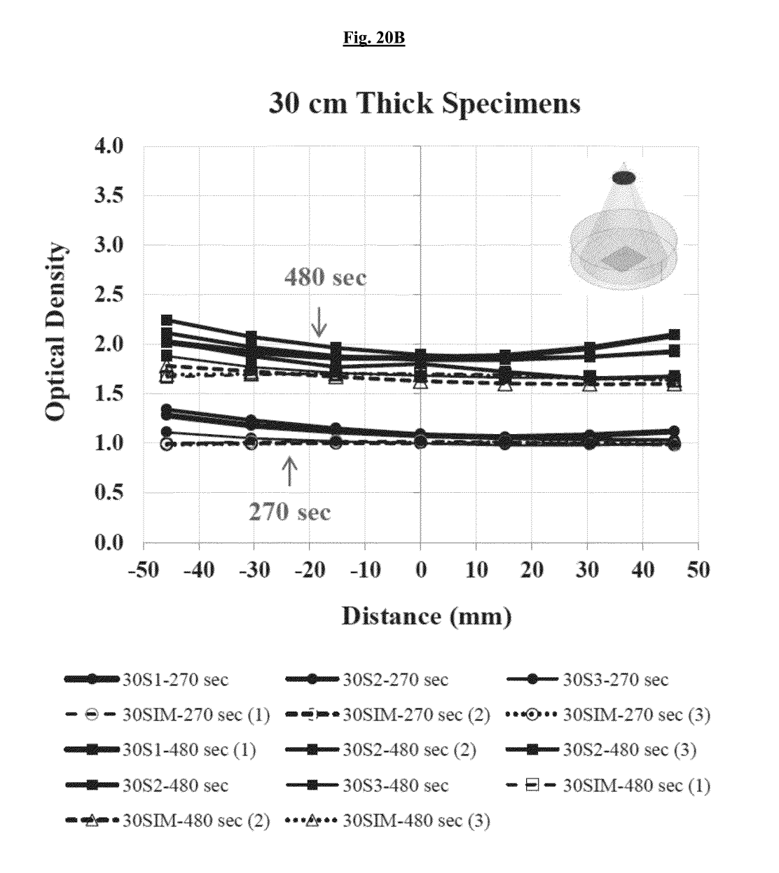

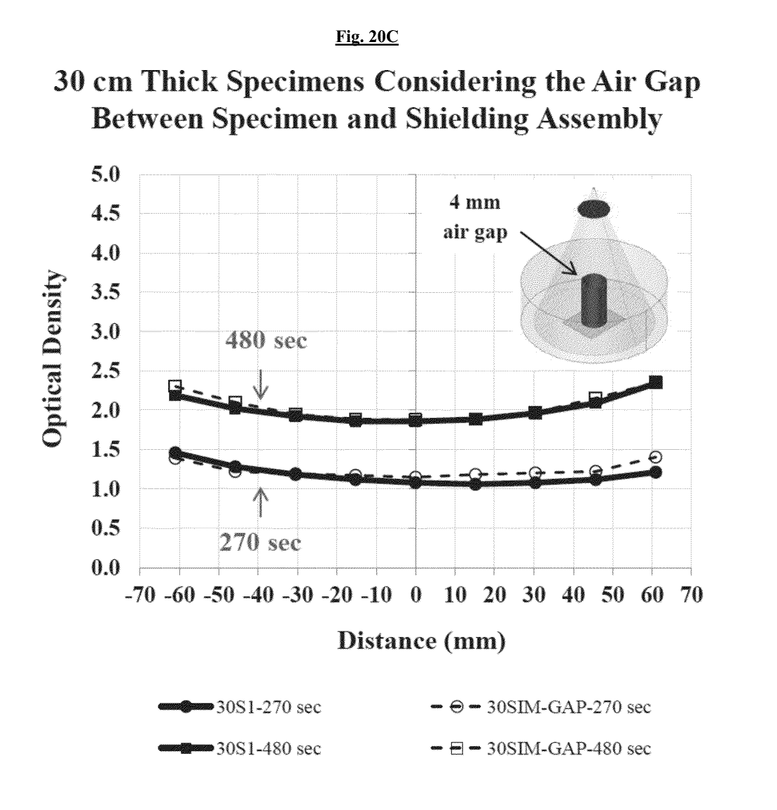

FIGS. 20A-20C are a set of graphs illustrating optical density readings obtained for the materials contemplated. The data in FIG. 20C takes into account the air gap between specimens and the shielding assembly.

Studies may comprise the following tasks: (1) optimization of radiographic testing practices for grout void and corrosion detection, and identification of design/detailing features that inhibit detection capabilities; (2) evaluation of photon attenuating inclusions (PAI) for enhancing grout void detection; (3) optimization of structural detailing for grout void and corrosion detection; (4) experimental radiographic testing; and (5) development of recommendations for practical implementation.

Optimization of Radiographic Testing Practices for Grout Void and Corrosion Detection; Identification of Design/Detailing Features that Inhibit Detection Capabilities

In order to characterize the capabilities and limitations of radiographic testing for grout void and corrosion detection in post-tensioning tendons and tendon anchorage regions, a series of simulated radiographic tests of representative concrete bridge girder sections are performed in CIVA RT. The numerical simulations are used to optimize radiographic test parameters (e.g., source emission spectrum, transmission time, detector sensitivity/resolution, and test configuration) to enhance detection capabilities, and to identify design/detailing features that inhibit grout void and corrosion detection.

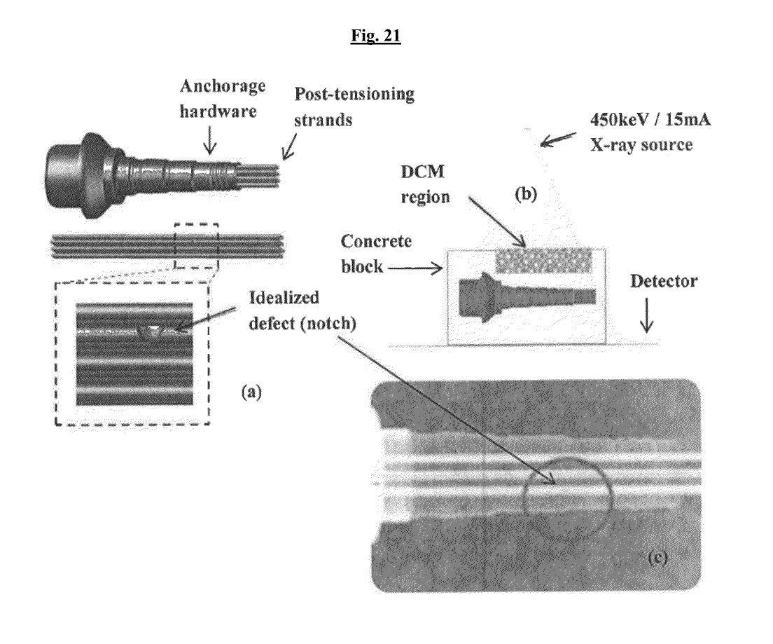

As an illustration of the modeling capabilities in CIVA RT, FIG. 21 illustrates an exemplary trial study that investigated a post-tensioning anchor embedded in a 60 cm×60 cm×60 cm cement mortar block with an isolated region containing course aggregate. The anchor housed seven 16 mm diameter steel strands, with an idealized defect built into one of the strands within the shaft of the anchor. For computational efficiency, the entire assembly was scaled to 50%. As shown in FIG. 21, panel (c), the defect was apparent in the virtual radiograph.

Evaluation of Photon Attenuating Inclusions (PAI) for Enhancing Grout Void Detection

The study comprises investigating the use of a novel approach to enhancing grout void detection in post-tensioning tendons and tendon anchorage regions that involves seeding the grout with photon attenuating inclusions (PAI) to alter the radiation attenuation characteristics of the material. In certain embodiments, an increase in radiation attenuation in grouted tendon and anchorage regions, relative to the attenuation in voided or water-filled regions, enhances contrast in radiographic images and improves void identification and measurement capabilities. In other embodiments, PAI seeding in the range of 5-10% volume fraction can increase the relative difference in pixel intensity values between grouted and voided regions without obscuring the inspection of the post-tensioning steel.

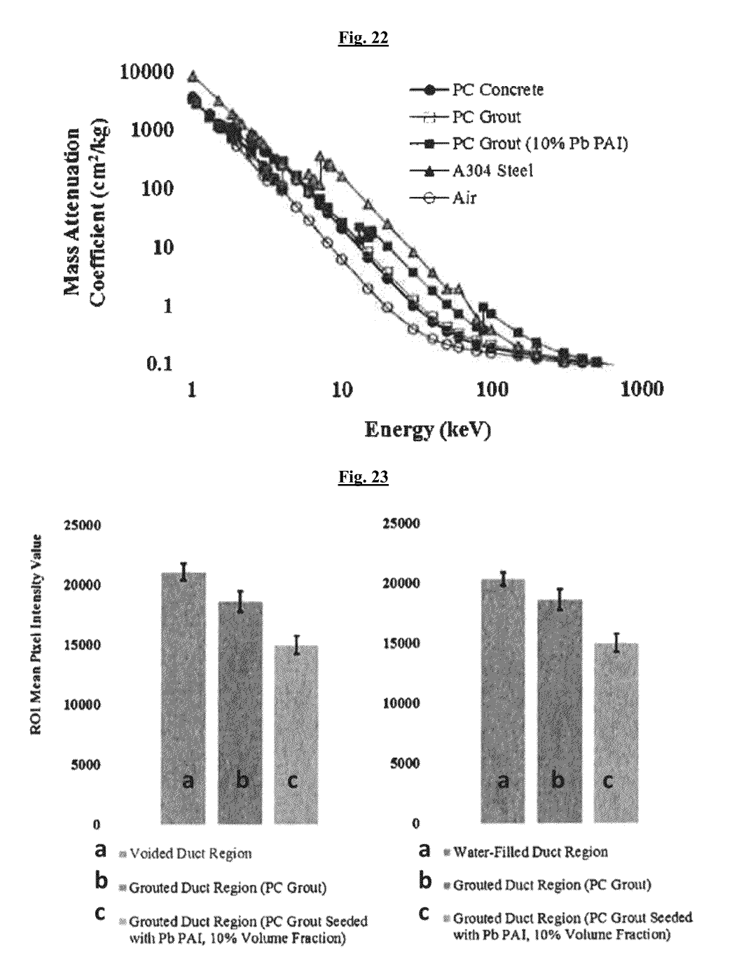

For illustration purposes, an exemplary CIVA RT study investigated two partially grouted 5 cm diameter post-tensioning tendons (where grout was absent in half of the duct length) embedded within a 25 cm thick concrete slab. One of the ducts was grouted with a conventional formulation of Portland cement (PC) grout, while the grouted region in the other duct was seeded with a 10% volume fraction of lead (Pb) PAI. As illustrated in FIG. 22, the introduction of Pb PAI increased the effective mass attenuation coefficient for the material by a factor of 2, and resulted in a gain of roughly 30% in effective density. The observed gain in radiation attenuation for the material was largely concentrated between 10 keV and 500 keV, which constitutes a relatively large energy range in the X-ray source emission spectrum.

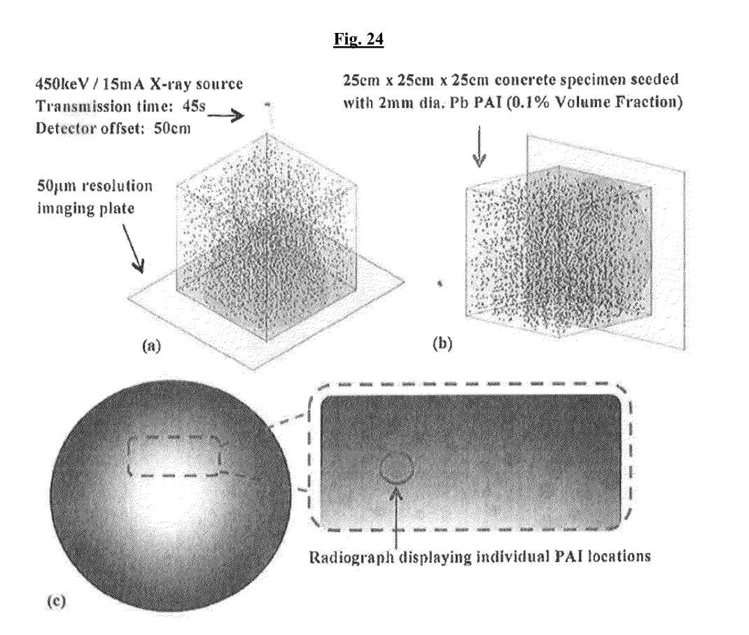

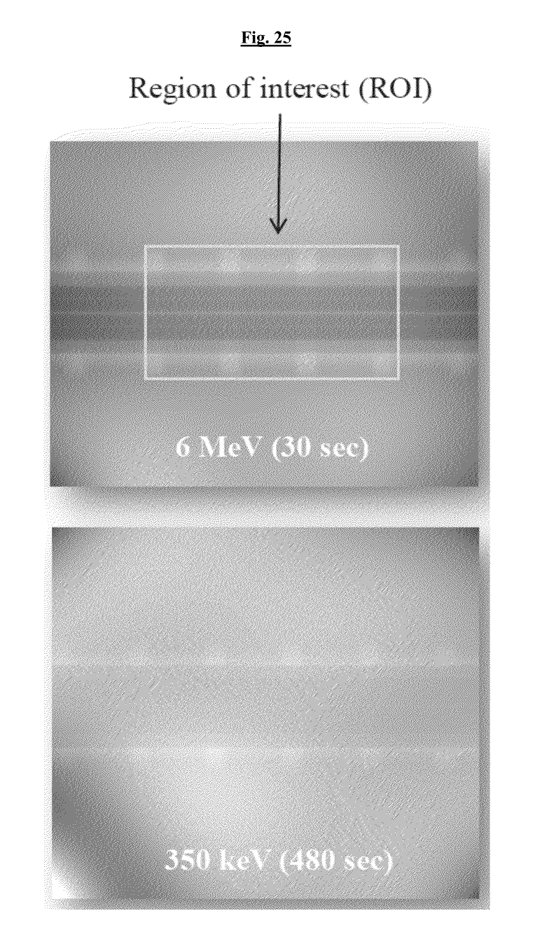

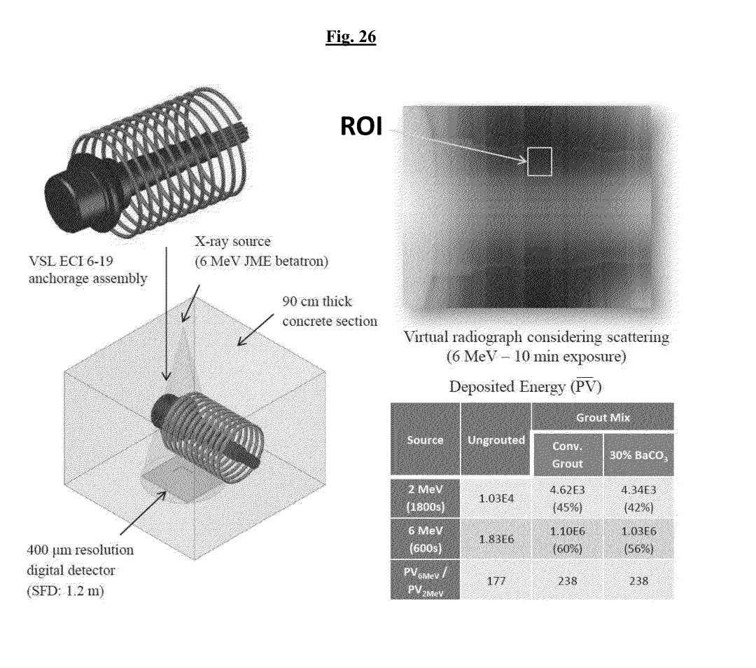

Mean pixel intensity values in the regions of interest (ROI), i.e., the grouted or voided duct regions, are illustrated in FIG. 23. The use of PAI seeding resulted in a mean pixel intensity in the grouted region that was 40% larger than the voided region, compared to a 16% differential for conventional grout. When the ungrouted region was filled with water, the difference in mean pixel intensity between the grouted and the water-filled cavity was increased by 20% with PAI seeding. The exemplary study thus provides an illustrative example of how PAI seeding can enhance contrast in digital radiographs and improve void detection capabilities for cementitious materials.

The exemplary study therefore provides an illustrative example of how PAI seeding can enhance contrast in digital radiographs and improve void detection capabilities for cementitious materials. In addition to the accumulated gain in radiation shielding over the volume of seeded material, the use of PAI in cementitious materials also increases local contrast in radiographic images. When PAI size and concentration are favorably selected, projected images of individual PAIS are discernible in the radiograph, and can serve as reference points for pattern recognition and measurement algorithms. Since the projected PAI images provide positional information (i.e., the location and size of projected PAI images can be related to a unique position within the material between the source and detector), PAI seeding can facilitate 3D image reconstruction of the surveyed volume. As an illustration of this approach, FIG. 24 illustrates a virtual radiograph generated for a concrete block seeded with 2 mm diameter Pb PAI. Individual PAI locations were discernible in the image, providing valuable information regarding the spatial distribution of the PAI population.

The study further provides data regarding the radiation attenuation characteristics of PAI seeded grouts and the efficacy of PAI seeding approaches. A numerical simulation-based approach (similar to the exploratory study) is used for process development. The study investigates two PAI materials (lead and carbon/stainless steel), three PAI delivery forms (powder, fibers, and spheres), and two PAI concentrations (5% and 10% volume fractions). In order to evaluate the effect of PAI seeding on the rheological and mechanical response of the parent material, the PAI seeded grout formulations is evaluated in accordance with ASTM C939-10: Standard Test Method for Flow of Grouts (ASTM, 2010a), ASTM C940-10: Standard Test Method for Expansion and Bleeding of Grouts (ASTM, 2010b), ASTM C942-10: Standard Test Method for Compressive Strength of Grouts (ASTM, 2010c), ASTM C953-10: Standard Test Method for Time of Setting of Grouts (ASTM, 2010d), ASTM C1090-10: Standard Test Method for Grout Permeability (ASTM, 2010e), and ASTM C1202-12: Standard Test Method for Measuring Volumetric Change of Grouts (ASTM, 2012). In certain embodiments, introduction of PAI seeding does not degrade the workability or expected in-service performance of the material.

Optimization of Structural Detailing for Grout Void and Corrosion Detection

Modifications that improve grout void and corrosion detection in post-tensioning tendon and tendon anchorage regions are investigated. A numerical simulation-based research approach is utilized because it offers good parametric control and efficiency as compared with experimental testing.

Experimental Radiographic Testing

In order to experimentally validate the findings from the numerical studies, a series of laboratory specimens representative of concrete bridge girder tendon and anchorage regions are developed and imaged using radiographic testing. The radiographic testing is performed by an industrial radiography contractor (Laboratory Testing, Inc.). The study may further include specimens with a range of relative void sizes, void conditions (air or water-filled cavities), corrosion damage, and both conventional and PAI seeded grouts. Computed radiography testing with high-resolution imaging plates are utilized, and the digital radiographs are analyzed for relative pixel intensity distribution to characterize defect detection capabilities.

Development of Recommendations for Practical Implementation.

Findings from the study are used to draft recommendations for structural design/detailing procedures and radiographic testing practices that improve radiographic inspection for grout voids (corrosion prevention) and corrosion (early detection and evolution over time) in post-tensioning tendon and tendon anchorage regions.

The disclosures of each and every patent, patent application, and publication cited herein are hereby incorporated herein by reference in their entirety.

While the invention has been disclosed with reference to specific embodiments, it is apparent that other embodiments and variations of this invention may be devised by others skilled in the art without departing from the true spirit and scope of the present invention. The appended claims are intended to be construed to include all such embodiments and equivalent variations.

What is claimed is:

1. A composition comprising a construction material and at least one photon attenuation inclusion (PAI) particle, wherein for at least one X-ray radiation level the radiation attenuation coefficient of the composition is at least 5% higher than the radiation attenuation coefficient of the composition in the absence of the at least one PAI particle.

2. The composition of claim 1, wherein the composition consists essentially of the construction material and the at least one PAI particle.

3. The composition of claim 1, wherein the radiation attenuation coefficient of the composition is at least 50% higher than the radiation attenuation coefficient of the composition in the absence of the at least one PAI particle.

4. The composition of claim 1, wherein the % PAI volume fraction in the composition ranges from about 1% to about 75%.

5. The composition of claim 4, wherein the % PAI volume fraction in the composition ranges from about 5% to about 20%.

6. The composition of claim 5, wherein the % PAI volume fraction in the composition ranges from about 5% to about 10%.

7. The composition of claim 1, wherein the PAI is at least one selected from the group consisting of a lead source, iron, carbon/stainless steel, and a barium source.

8. The composition of claim 7, wherein the lead source is at least one selected from the group consisting of elemental lead. a lead oxide, a lead hydroxide, and a lead salt.

9. The composition of claim 7, wherein the barium source is at least one selected from the group consisting of a barium salt, a barium hydroxide, and a barium oxide.

10. The composition of claim 9, wherein the barium salt is at least one selected from the group consisting of barium sulfate and barium carbonate.

11. The composition of claim 1, wherein the construction material comprises at least one selected from the group consisting of concrete, clay, grout, sand, aggregate, masonry and steel-concrete.

12. The composition of claim 11, wherein the construction material comprises cementitious grout.

13. The composition of claim 1, wherein the PAI is in at least one form selected from the group consisting of powder, fiber, sphere, pellet, slurry and liquid.

14. The composition of claim 1, wherein the at least one X-ray radiation level ranges from about 1 keV to about 10 MeV.

15. The composition of claim 14, wherein the at least one X-ray radiation ranges from about 10 keV to about 500 keV.

16. The composition of claim 1, wherein the PAI has a pair production threshold energy, and wherein the at least one X-ray radiation level is about equal to or lower than the PAI's pair production threshold energy.

17. A method of performing radiographic inspection of a composition, wherein the composition is in contact with a physical structure, the method comprising the steps of exposing at least one point of the composition to X-ray radiation of a first energy level and measuring radiation that emerges from the composition, thereby obtaining a first radiographic image of the composition,
wherein the composition comprises a construction material and at least one photon attenuation inclusion (PAI) particle,
wherein for the first X-ray radiation energy level the radiation attenuation coefficient of the composition is at least 5% higher than the radiation attenuation coefficient of the composition in the absence of the at least one PAI particle.

18. The method of claim 17, wherein the composition comprises cement.

19. The method of claim 17, wherein the composition comprises cementitious grout.

20. The method of claim 17, wherein the physical structure comprises at least one selected from the group consisting of tendons and/or tendon anchorage regions around steel post-tensioning strands, grouted masonry construction, steel-concrete composite construction, and other forms of concrete construction.

21. The method of claim 20, the method further comprising exposing at least one point of the physical structure in the absence of the composition to X-ray radiation of a given energy level and measuring radiation that emerges from the physical structure in the absence of the composition, thereby obtaining a radiographic image of the physical structure in the absence of the composition.

22. The method of claim 21, the method further comprising comparing the radiographic image of the composition and the radiographic image of the physical structure in the absence of the composition, thereby obtaining a radiographic image of the composition with improved contrast-to-noise ratio.

23. The method of claim 17, wherein analysis of the radiographic image of the compositions allows for detection of at least one selected from the group consisting of a void, multiple voids, fracture and crack.

24. The method of claim 17, the method further comprising exposing at least one point of the composition to X-ray radiation of a second energy level and measuring radiation that emerges from the composition, thus obtaining a second radiographic image of the composition, wherein the first energy is distinct from the second energy, wherein for the second X-ray radiation energy level the radiation attenuation coefficient of the composition is at least 5% higher than the radiation attenuation coefficient of the composition in the absence of the PAI.

25. The method of claim 24, the method further comprising applying a first scale factor to the first radiographic image to generate a first scaled image, applying a second scale factor to the second radiographic image to generate a second scaled image, and combining the first and second scaled images to generate an enhanced radiographic image, wherein the first and second scale factor are selected such that the image of the physical structure is substantially suppressed in the enhanced radiographic image.

26. The method of claim 24, wherein the first and second energies are independently in the range of about 1 MeV to about 10 MeV.

27. The method of applying a composition to a physical structure, the method comprising contacting the composition with the physical structure, wherein the composition comprises a construction material and at least one photon attenuation inclusion (PAI) particle, wherein for at least one X-ray radiation level the radiation attenuation coefficient of the composition is at least 5% higher than the radiation attenuation coefficient of the composition in the absence of the at least one PAI particle.

28. The method of claim 27, wherein the composition is fluid when contacted with the physical structure and becomes rigid after a curing time.

29. The method of claim 28, further comprising performing radiographic inspection of the composition when the composition is in contact with the physical structure, at a time point that is shorter than the composition's curing time.

30. The method of claim 28, further comprising performing radiographic inspection of the composition when the composition is in contact with the physical structure, at a time point that is equal to or longer than the composition's curing time.

31. A kit comprising at least one photon attenuation inclusion (PAI) particle, an applicator and instructional material, wherein the instructional material recites the preparation of a composition comprising a construction material and the at least one PAI particle, wherein for at least one X-ray radiation level the radiation attenuation coefficient of the composition is at least 5% higher than the radiation attenuation coefficient of the composition in the absence of the at least one PAI particle.
